(19) United States
(12) Patent Application Publication
(10) Pub. No.: US 2025/0036140 A1
(43) Pub. Date: Jan. 30, 2025

(54) SYSTEMS AND METHODS FOR CLEANING ROBOTS

(71) Applicant: The Procter & Gamble Company, Cincinnati, OH (US)

(72) Inventors: Joost DEBONTH, Schaarbeek (BE); Matthew Stephen BAUER, Loveland, OH (US); Eric Gunnar HURD, Cincinnati, OH (US); Su Yon CHANG, Cincinnati, OH (US); Noah Tyler KIRST, Alexandria, KY (US); Ankur Kumar CHOUDHARY, Frankfurt am Main (DE)

(21) Appl. No.: 18/780,840

(22) Filed: Jul. 23, 2024

Related U.S. Application Data
(60) Provisional application No. 63/515,467, filed on Jul. 25, 2023.

(51) Int. Cl. G05D 1/628; G05D 1/241; G05D 1/242; G05D 105/10; G05D 107/40

(52) U.S. Cl. CPC G05D 1/628; G05D 1/241; G05D 1/242; G05D 2105/10; G05D 2107/40

(57) ABSTRACT

A robot is described herein comprising high fidelity sensor control (e.g., via joystick or other data rich sensors) for robotic cleaning and navigation strategies. The robot may be sized or dimensioned for maneuvering for cleaning, disinfecting, or otherwise improving a physical environment (e.g., living spaces, office spaces, or the like), especially those having narrow or varied spaces created by obstacles within the physical environment. The cleaning robot as described herein provide solutions for overcoming problems that arise from cleaning target areas or environments that have typically been hard for conventional robots to clean, fit, and/or maneuver within.

### FIELD

The present disclosure generally relates to robots, such as cleaning robot automation, and, and more particularly to, the field of robotics applied to cleaning, disinfecting, or otherwise improving a physical environment (e.g., living spaces, office spaces, or the like), especially those having narrow or varied spaces created by obstacles within the physical environment.

### BACKGROUND

Existing cleaning robots lack the ability to maneuver or navigate into complex, e.g., narrow and/or variable, spaces within a given physical environment. Typically, such cleaning robots are designed to have a wide or otherwise large cleaning footprint designed to clean a wide open area as the robot moves within a given space. Such large design, however, is prohibitive to effective cleaning in complex spaces, leaving such spaces uncleaned or otherwise unaffected by the cleaning robot.

Further, given their large size, conventional cleaning robots lack fine motor control necessary to navigate or move within complex spaces. While these conventional robots can perform algorithms to clean a large space they fail to account for tight spaces and corners that are typically the most difficult to clean. This issue is especially problematic because physical environments can differ widely by having different shapes, sizes, and dimensions which prohibits large size robots from effective maneuvering, navigating, or otherwise operating to provide a thorough clean.

For the foregoing reasons, there is a need for a robot configured for cleaning, disinfecting, or otherwise improving a physical environment (e.g., living spaces, office spaces, or the like), especially those having narrow or varied spaces created by obstacles within the physical environment, or as otherwise created by the physical environment itself, as further described herein.

### SUMMARY

Generally, a cleaning robot is described herein. The cleaning robot may comprise high fidelity sensor(s) (e.g., joystick or other data rich sensors) for accurate control, maneuverability, or otherwise advanced robotic navigation strategies. Further, in various aspects, the cleaning robot may be sized or dimensioned for maneuvering, cleaning, disinfecting, or otherwise improving a physical environment (e.g., living spaces, office spaces, or the like), especially in areas having narrow or varied spaces created by obstacles or edges (e.g., walls) within the physical environment. The cleaning robots as described herein provide solutions for overcoming problems that arise from cleaning target areas or environments that have typically been hard for conventional robots to clean, fit, and/or maneuver within.

More specifically, in some aspects, a robot may be configured for cleaning an environment. The robot may comprise a body that includes a chassis and an outer perimeter. The robot may further comprise a motor configured to move the robot within an environment. The robot may further comprise a multi-directional sensor comprising a plurality of radial zones, wherein each radial zone defines direction relative to the robot. The robot may further comprise a processor and a computer memory, each communicatively coupled to the multi-directional sensor. The robot may further comprise computing instructions stored on the computer memory and configured, when executed by the processor, to cause the processor to receive sensor data from the multi-directional sensor when at least a portion of the outer perimeter of the body of the robot contacts an object in the environment. The computing instructions may further be executed by the processor to cause the processor to actuate the motor based on the sensor data to cause the robot to alter its course.

In addition, as described herein, a robot may be configured for cleaning an environment via one or more navigation strategies. In such aspects, a robot is configured for cleaning where the robot includes a body comprising a chassis and a cleaning element. The robot may further comprise a motor configured to move the robot within an environment. The robot may further comprise a sensor and a processor communicatively coupled to the sensor. The robot may further comprise a computer memory communicatively coupled to the processor. The robot may further comprise computing instructions stored on the computer memory and configured, when executed by the processor, to cause the processor to actuate the motor to drive the robot in a forward direction relative to the cleaning element. The computing instructions, when executed by the processor, may further cause the processor to receive sensor data from the sensor. The sensor data may indicate an object in the environment relative to the robot. The computing instructions, when executed by the processor, may further cause the processor to actuate the motor based on the sensor data to cause the robot to alter its course while maintaining the forward direction relative to the cleaning element.

In still further aspects, a robot may be configured for cleaning. The robot may comprise a body comprising a chassis. The robot may further comprise a cleaning element comprising a substate mount for receiving and holding a disposable hard surface wiping substate. The substate mount may have a width where the width is measured generally perpendicular to a forward direction of travel of the robot. The width may be less than or equal to about 13.9 cm. The robot may further comprise a motor configured to move the robot within an environment. The robot may further comprise a sensor and a processor communicatively coupled to the sensor. The robot may further comprise a computer memory communicatively coupled to the processor. The robot may further comprise computing instructions stored on the computer memory and configured, when executed by the processor, to cause the processor to: (i) receive sensor data from the sensor, and (ii) actuate the motor based on the sensor data to cause the robot to maneuver within the environment. The robot may be sized and dimensioned in various configurations and/or the computing instructions of the robot may be configured to maneuver the robot such that the robot may clean various aspects of a given environment. For example, in in various aspects, the robot may be configured in one or more following manners. The manners may include, by way of non-limiting example, where the robot is configured, when the processor executes the computing instructions, to maneuver within the environment by implementing a predefined number of passes. Additionally, or alternatively, the robot may be further configured, when the processor executes the computing instructions, to maneuver within the environment by implementing a predefined speed for each pass. Additionally, or alternatively, the robot may have a height of 9 centimeters or less. Additionally, or alternatively, the body of the robot may comprise a bumper having a corner radius between 0.5 millimeters to 30 millimeters. Additionally, or alternatively, the cleaning element of the robot may have a turn radius of less than 27.5 centimeters. Additionally, or alternatively, the body of the robot may comprise a bumper having at least a front bumper portion. In such aspects, the cleaning element may comprise at least a front cleaning element portion where a distance from the front bumper portion to the front cleaning element portion is less than 10 millimeters. Additionally, or alternatively, the body of the robot may comprise a bumper having at least a side bumper portion. In such aspects, the cleaning element may comprise at least a side cleaning element portion where a distance from the side bumper portion to the side cleaning element portion is less than 10 millimeters.

The present disclosure relates to improvements to other technologies or technical fields at least because the present disclosure describes or introduces improvements to computing devices in the field of robotics, whereby a cleaning robot, as described herein, may comprise high fidelity sensor control (e.g., via joystick or other data rich sensors) for robotic navigation strategies. Still further, in some aspects a sensor may be limited to one or more directions of travel and/or one or more distances of travel within or with respect to the body of the robot to prevent a sensor from moving to a fully actuated position. For example, in such aspects, by preventing or avoiding actuating a multi-directional sensor to a fully actuated position, the longevity and/or operation of the sensor, as well as its data fidelity, may be improved or extended, thereby improving and/or prolonging the accuracy and operating efficiency of the robot itself.

The present disclosure includes applying the certain of the claim elements with, or by use of, a particular machine, e.g., a robot configured for cleaning, disinfecting, or otherwise improving a physical environment (e.g., living spaces, office spaces, or the like).

In addition, the present disclosure includes specific features other than what is well-understood, routine, conventional activity in the field, and that add unconventional steps that confine the claim to a particular useful application, e.g., cleaning robots configured to clean, disinfect, and/or otherwise improve a physical environment (e.g., living spaces, office spaces, or the like), especially those having narrow or varied spaces created by obstacles within the physical environment.

Advantages will become more apparent to those of ordinary skill in the art from the following description of the preferred aspects which have been shown and described by way of illustration. As will be realized, the present aspects may be capable of other and different aspects, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the system and methods disclosed therein. It should be understood that each Figure depicts a particular aspect of the disclosed system and methods, and that each of the Figures is intended to accord with a possible aspect thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present aspects are not limited to the precise arrangements, orientations, and/or instrumentalities shown, wherein:

FIG. 1 illustrates a perspective view of an example robot for cleaning or otherwise interacting with a space or environment in accordance with various aspects disclosed herein.

FIG. 2A illustrates an exploded view of a portion of the example robot of FIG. 1 in accordance with various aspects disclosed herein.

FIG. 2B illustrates a further exploded view of the example robot of FIG. 1 in accordance with various aspects disclosed herein.

FIG. 2C illustrates a top-down cross-sectional view of the example robot of FIG. 1 in accordance with various aspects disclosed herein.

FIG. 3 illustrates a top view of the example robot of FIG. 1 in accordance with various aspects disclosed herein.

FIG. 4 illustrates a bottom view of the example robot of FIG. 1 in accordance with various aspects disclosed herein.

FIG. 5 illustrates a side view of the example robot of FIG. 1 in accordance with various aspects disclosed herein.

FIG. 6 illustrates a rear view of the example robot of FIG. 1 in accordance with various aspects disclosed herein.

FIG. 7 illustrates a front view of the example robot of FIG. 1 in accordance with various aspects disclosed herein.

FIG. 8 illustrates an example environment in which the robot of FIG. 1 can navigate or otherwise move within in accordance with various aspects disclosed herein.

FIG. 9A illustrates an example multi-directional sensor in accordance with various aspects disclosed herein.

FIG. 9B illustrates the example multi-directional sensor of FIG. 9A with an example plurality or set of plurality of radial zones in accordance with various aspects disclosed herein.

FIG. 10A illustrates an example magnetic-based multi-directional sensor configuration in accordance with various aspects disclosed herein.

FIG. 10B illustrates an example Hall-effect-based multi-directional sensor configuration in accordance with various aspects disclosed herein.

FIG. 10C illustrates an example Time-of-Flight (ToF) s-based multi-directional sensor configuration in accordance with various aspects disclosed herein.

FIG. 11A illustrates a coverage diagram showing example navigation or movement of a robot within an environment in accordance with various aspects disclosed herein.

FIG. 11B illustrates a flowchart for navigation algorithm in accordance with various aspects disclosed herein.

FIG. 11C illustrates a flowchart for edge navigation algorithm in accordance with various aspects disclosed herein.

FIG. 11D illustrates a further flowchart portion of the edge navigation algorithm of FIG. 11A in accordance with various aspects disclosed herein.

FIG. 11E illustrates a further flowchart portion of the edge navigation algorithm of FIG. 11A in accordance with various aspects disclosed herein.

FIG. 11F illustrates an additional coverage diagram showing a further example navigation or movement of a robot within an environment in accordance with various aspects disclosed herein.

FIG. 12A illustrates example navigation or movement of a robot within an environment in accordance with various aspects disclosed herein in accordance with various aspects disclosed herein.

FIG. 12B illustrates example navigation or movement of a robot to reacquire, recapture, or recollect debris after interaction with an obstacle in accordance with various aspects disclosed herein.

FIG. 12C illustrates example navigation or movement of a robot to minimize or prevent debris falloff when the robot is turning in accordance with various aspects disclosed herein.

FIG. 13 illustrates example navigation or movement of a robot within an environment in accordance with various aspects disclosed herein in accordance with various aspects disclosed herein.

FIG. 14 illustrates example debris and sizes thereof in accordance with various aspects disclosed herein.

The Figures depict preferred aspects for purposes of illustration only. Alternative aspects of the systems and methods illustrated herein may be employed without departing from the principles of the invention described herein.

### DETAILED DESCRIPTION OF THE INVENTION

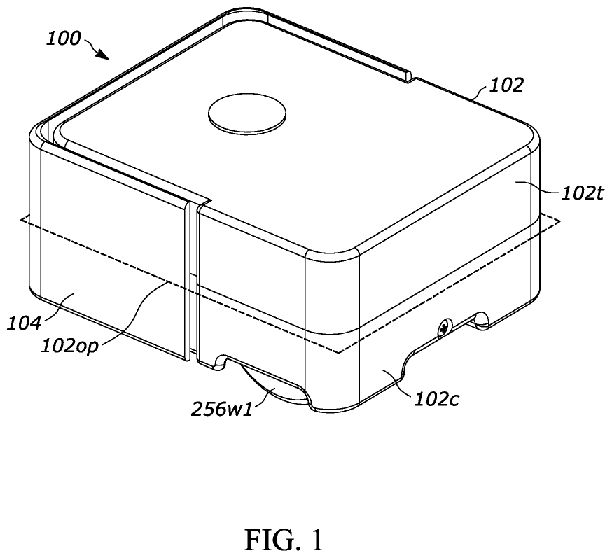

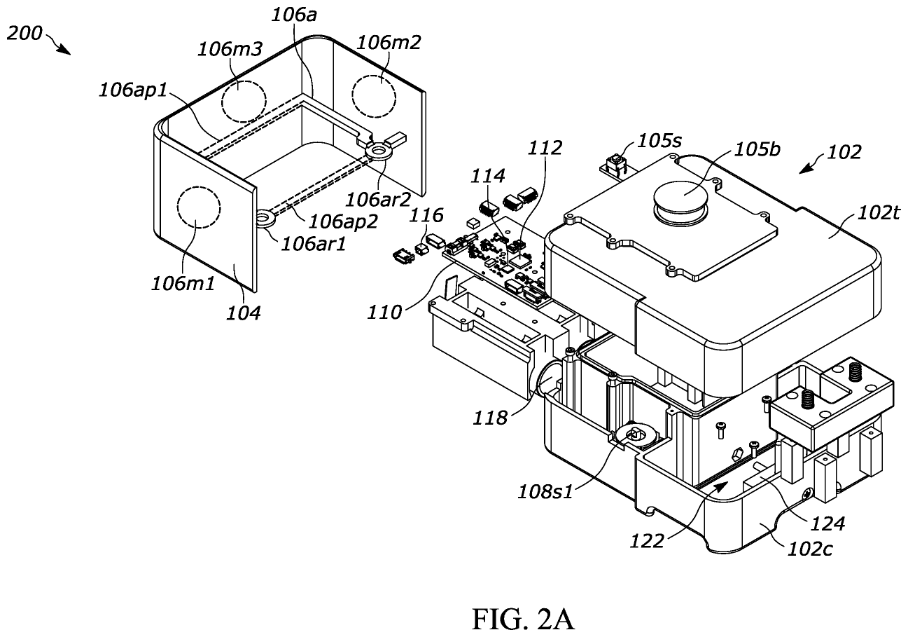

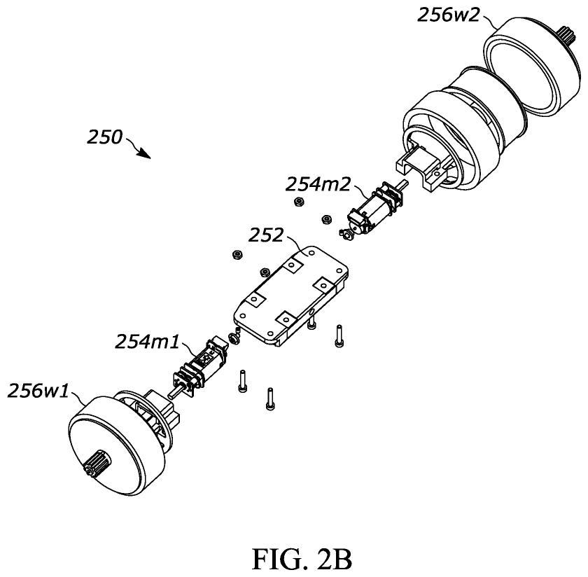

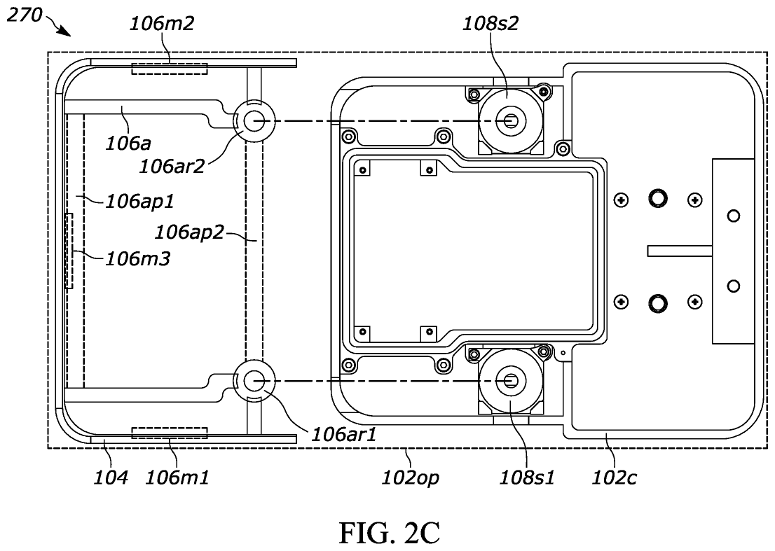

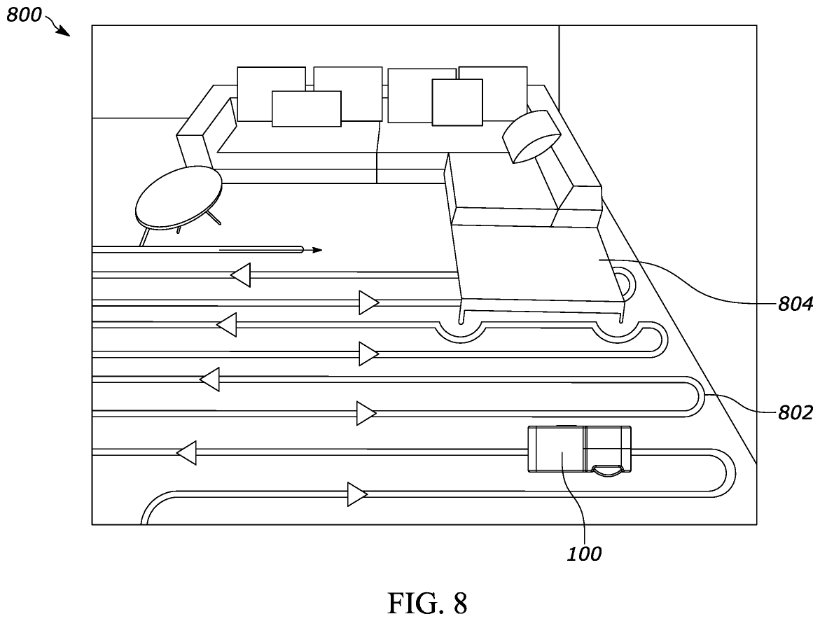

FIG. 1 illustrates a perspective view of an example robot 100 for cleaning or otherwise interacting with a space or environment in accordance with various aspects disclosed herein. As shown in the example of FIG. 1, the robot includes a body 102 comprising a chassis 102c and an outer perimeter 102op. In various aspects, the outer perimeter 102op may comprise or otherwise be formed of various aspects or components of body 102 of robot 100, which may include, by way of non-limiting example, bumper 104, chassis 102c (e.g., the lower portion of body 102), and/or top 102t of body 102. It is to be understood, however, that an outer perimeter (e.g., outer perimeter 102op) can include additional, less, and/or different components of a given robot body (e.g., body 102). More generally, an outer perimeter (e.g., outer perimeter 102op) defines an outermost region of robot 102 which can come into contact (e.g., bump or hit) objects within a cleaning environment (e.g., environment 800 as shown for FIG. 8). Still further, an outer perimeter (e.g., outer perimeter 102) may be formed of a material such as a hard plastic such as polyethylene, or otherwise a material that would otherwise prevent (or mitigate) damage or mark a surface when the outer perimeter 102op of robot 100 comes into contact with an object (e.g., a wall, baseboard, or furniture) within the environment in which robot 100 is moving or otherwise operating. Further, FIG. 1 illustrates wheel 256w1, which a first wheel of robot 100. Additional figures herein (e.g., FIG. 2B) further describe example wheels of the robot 100 herein.

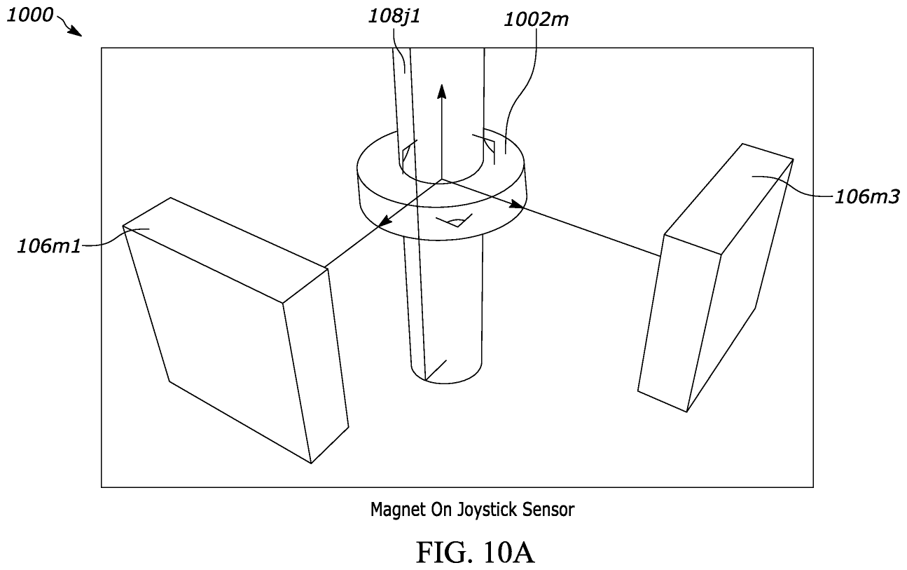

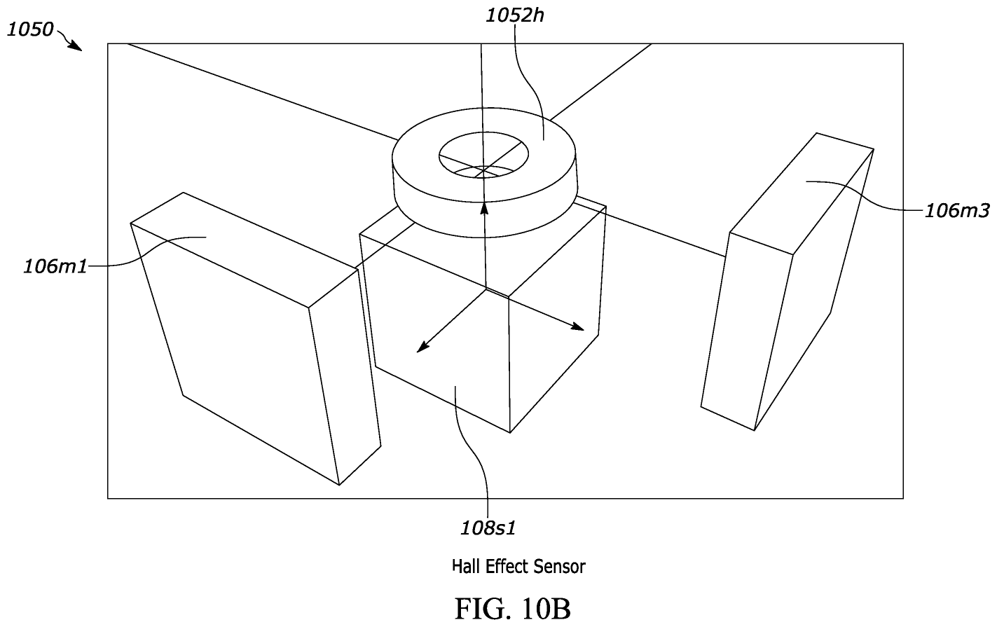

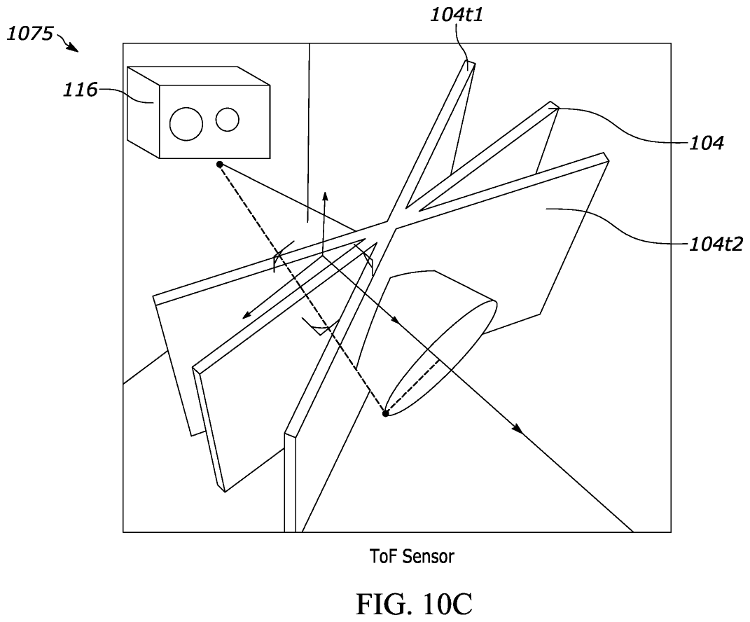

FIG. 2A illustrates an exploded view 200 of a portion of the example robot 100 of FIG. 1 in accordance with various aspects disclosed herein. In the example of FIG. 2A, body 102 of robot 100 is shown with its various components (but excluding wheels, which are further described herein with respect to additional figures, e.g., FIG. 2B). As shown for FIG. 2A, robot 100 comprises a bumper 104 configured to move relative to body 102 of robot 100. For example, bumper 104 may move towards body 102 of robot 100 when bumper 104 comes into contact with an object within an environment in which robot 100 is moving. In some aspects, bumper 104 comprises one or more magnets (e.g., any one or more of magnets 106m1, 106m2, and/or 106m3) positioned on, within, or partially within bumper 104. The magnets can be used to determine position of bumper 104 with respect to magnetic-based sensor(s) as described further herein, for example, with respect to FIG. 10A.

In further aspects, bumper 104 comprises an actuator (e.g., actuator 106a) configured to actuate one or more sensors (e.g., multi-directional sensors 108s1 and 108s2). Generally, an actuator (e.g., actuator 106a) is coupled to the one or more sensors (e.g., multi-directional sensors 108s1 and sensors 108s2) such that when bumper 104 comes into contact with an object in the environment, the actuator (e.g., actuator 106a) transfers force or otherwise provides information for detection by the one or more sensors (e.g., multi-directional sensors 108s1 and sensors 108s2). For example, when bumper 104 strikes an object, actuator 106a transfers force to multi-directional sensor 108s2 (e.g., as shown in FIG. 2C), where multi-directional sensor 108s2 is coupled to actuator 106a at actuator receiver 106ar2 (e.g., as shown in FIG. 2C). Similarly, when bumper 104 strikes an object actuator 106a transfers force to multi-directional sensor 108s1, where multi-directional sensor 108s1 is coupled to actuator 106a at actuator receiver 106ar1. The force transferred may comprise any directional force, including lateral, horizontal, and/or vertical, which may be sensed by a multi-directional sensor (e.g., multi-directional sensors 108s1 and sensors 108s2) of robot 100.

Further, in various aspects, actuator 106a may comprise various portions. For example, as shown for FIG. 2A actuator 106a may comprise portions 106ap1 and portions 106ap2, which are examples of cross arm or beam portions that, in some aspects, may form actuator 106a. The additional portions may transfer or distribute force to or among the various sensor(s) (e.g., multi-directional sensors 108s1 and sensors 108s2) thereby causing the sensor(s) to collect different data based on a location of the impact of a given object on bumper 104. For example, where actuator portion 106ap2 forms part of actuator 106a, an impact on bumper 104 nearer to actuator receiver 106ar2 would cause a greater amount of force to be transferred (across actuator portion 106ap2) to actuator receiver 106ar1. Thus, in such an example, multi-directional sensor 108s1 would sense or detect a greater degree of force (and thus generate a proportional degree of sensor data) than had actuator portion 106ap2 formed no part of actuator 106a.

As a further example, where actuator portion 106ap1 forms part of actuator 106a, an impact on a corner side of bumper 104 nearer to actuator receiver 106ar1 would cause a greater amount of force to transferred (across actuator portion 106ap1) to actuator receiver 106ar2. Thus, in such an example, multi-directional sensor 108s2 would sense or detect a greater degree of force data than had actuator portion 106ap1 formed no part of actuator 106a. It is to be understood, however, that additional, fewer, and/or different portions may be formed or otherwise configured for actuator 106a causing actuator receiver(s) (e.g., receiver 106ar1 and/or receiver 106ar2) to receive additional, fewer, and/or different force(s) thereby causing their respective sensors (e.g., multi-directional sensors 108s1 and sensors 108s2) to experience and detect different force or other data. In this way the sensor(s) and actuator(s) can be configured together to detect various fidelities, degrees, or otherwise types of sensor data in order to configure robot 100 to sense or respond to its environment and to navigate therein.

As further shown for FIG. 2A, a sensor multi-directional sensor (e.g., multi-directional sensors 108s1 and sensors 108s2) may be installed or otherwise position on body 102 for sensing, detecting, or otherwise receiving sensor data. The example embodiment of FIG. 2A illustrates multi-directional sensor 108s1 positioned on, in, or at partially within chassis 102c of robot body 102. Multi-directional sensor 108s2 is also positioned on chassis 102c as further shown for FIG. 2C herein. The multi-directional sensor(s) may fit or be otherwise be coupled to an actuator (e.g., actuator 106a of bumper 104) by receivers (e.g., receiver 106ar1 and/or receiver 106ar2) to receive and detect force or movement, and various degree(s) or otherwise amounts thereof. It is to be understood, however, that multi-directional sensor(s) may be positioned elsewhere on body 102 of robot 100. In some examples, one or more multi-directional sensor(s) may comprise Time-of-Flight sensor(s) where such sensor(s) may be positioned on a forward portion or other portion of robot 100.

Further with respect to FIG. 2A, robot 100 comprises a circuit board 110. Battery 118 may power circuit board 110 and its various components, which may include, by way of non-limiting example, a processor 112 and a memory 114. Processor 112 may be communicatively coupled to memory 114 via a computing bus of circuit board 110. Further, Processor 112 may be communicatively coupled to the multi-directional sensor(s) (e.g., multi-directional sensors 108s1 and sensors 108s2) for receiving sensor data from the sensor(s). Processor 112 may transfer to (e.g., store), and receive (e.g. load) from memory 114 information, including computing instructions and/or data (e.g., sensor data). For example, in various aspects, memory 114 comprises a computer memory storing computing instructions (e.g., firmware) on the computer memory for execution by processor 112. Processor 112 may receive sensor data from multi-directional sensor(s) (e.g., multi-directional sensors 108s1 and sensors 108s2), where computing instructions, loaded from memory 114, cause processor 112 to analyze the sensor data causing robot 100 to implement any of the algorithms, methods, processes, steps, and/or otherwise functionality describe herein. For example, the computing instructions may cause robot 100 to navigate in an environment, respond to objects or series of objects within the environment and/or surface types (e.g., different variations in surfaces or types thereof caused by a vent, register, or other such item causing a surface irregularity or difference in a floor area that the robot is operating with respect to), including processing or otherwise interpreting sensor data to determine how to operate when the robot, or portion thereof, comes into contact with an object within the environment. In various aspects, the computing instructions may be implemented in any desired program language (e.g., C, C++, C#, C, Java, or the like), and may be interpreted or executed as program code, machine code, assembly code, byte code, or the like.

Circuit board 110 may further comprise a Time-of-Flight (ToF) sensor 116 that may be positioned to scan, image, or detect an interior surface of robot 100, such as the interior surface of bumper 104. The ToF sensor 116 may scan the bumper 104 surface several times per second to determine a distance or magnitude of travel of the surface of bumper 104 for the purpose of detecting, e.g., via a degree of travel or movement of the bumper surface, an impact on the bumper 104 by an obstacle in an environment in which the robot 100 moves.

FIG. 2A further illustrates a cavity 122 which comprises a wheel well for housing a wheel structure as illustrated for FIG. 2B. The wheel structure may be attached by pivot plate 124 for pivoting the wheel structure or otherwise allowing the wheels structure to move, dampen, and/or respond to floor surface(s) and/or obstacles.

Robot 100 may further comprise a button 105b that when depressed activates a switch 105s. Switch 105s may be communicatively coupled to processor 112, such that when pressed, sends a single causing processor 112 to perform various functions, including turning a state of the robot on, off, cycling through various modes of operation of the robot, and/or otherwise implementing any of the algorithms, flowcharts, or instructions as described herein.

FIG. 2B illustrates a further exploded view 250 of the example robot 100 of FIG. 1 in accordance with various aspects disclosed herein. In the example of FIG. 2B, wheels of robot 100 are shown with various components. These components are configured to fit or otherwise be installed into cavity 122 of robot 100 and attached to pivot plate 124, as described herein for FIG. 2A. For example, the wheel structure as shown for FIG. 2A may comprise a wheelbase 252 configured to receive (e.g., via screws) motor 254m1 and motor 254m2. Each of motors 254m1 and 254m2 may couple to (e.g., be positioned within or partially within) wheels 256w1 and 256w2. Each of motors 254m1 and 254m2 may comprise electric motors (e.g., a 12-volt direct current (DC) motor) that may comprise a gearbox and/or shaft(s) for rotating a turning a wheel or tire, e.g., via a cogged base wheel, such as shown for each of wheels 256w1 and 256w2. By way of non-limiting example, motors 254m1 and 254m2 may be brush or brushless motor(s) having gear assemblies and electronics for rotating the wheels when a power source is applied (e.g., battery 118). It is to be understood, however, that additional, fewer, and/or different motor(s) or types thereof may be used to move or drive robot 100.

Wheelbase 252 as shown for FIG. 2A may be attached (e.g., via screw(s)) to pivot plate 124 of robot 100 allowing the wheelbase (e.g., and thus wheels 256w1 and 256w2) to tilt and/or pivot, which allows the wheel structure, as a whole, to respond to a floor surface and/or variances thereof (caused by a non-level floor, bumps, etc.) of an environment by absorbing shock or conforming to the floor or otherwise variance.

As shown for FIG. 2B, motor 254m1 and motor 254m2 may be coupled to wheel 256w1 and wheel 256w2 respectively. Motor 254m1 is configured to drive or rotate wheel 256w1 forward and backward. Likewise, motor 254m2 is configured to drive or rotate wheel 256w2 forward and backward. Processor 112 may be communicatively coupled to each of the motor(s) to send signals to cause the motors to drive, actuate, or otherwise move robot 100 in various directions or manners (e.g., forward, backward, rotating, etc.) within a given environment.

FIG. 2C illustrates a top-down cross-sectional view 270 of the example robot of FIG. 1 in accordance with various aspects disclosed herein. Robot 100 comprises an example robotic configuration comprising two sensors, that is, a first sensor and a second sensor, which may each comprise multi-directional sensors as shown embedded or at least partially within chassis 102c. In particular, as illustrated for FIG. 2C, robot 100 includes multi-directional sensor 108s1 and multi-directional sensor 108s2. In various aspects, processor 112 may execute computing instructions, stored in memory 114, that when executed by the processor, cause processor 112 to receive first sensor data from multi-directional sensor 108s1 and/or second sensor data from multi-directional sensor 108s2 when at least a portion (e.g., bumper 104) of the outer perimeter (e.g., outer perimeter 102op) of the body 102 contacts an object (e.g., obstacle 804) in a given environment (e.g., environment 800). The first and/or second sensor data may be analyzed by processor 112, which may respond by actuating a motor (e.g., motor 254m1 and/or motor 254m2) based on the first and/or second sensor data to cause the robot to alter its course in the environment (e.g., example environment 800) in order to navigate or traverse the obstacle (e.g., obstacle 804).

In the example of FIG. 2C, each of multi-directional sensor 108s1 and multi-directional sensor 108s2 are coupled to at least a portion of the outer perimeter 102op via a multi-axis sensor actuator (e.g., actuator 106a). More generally, a given sensor (e.g., multi-directional sensor 108s1 and/or multi-directional sensor 108s2) may be coupled to a portion of the robot (e.g., bumper 104) that forms an outer perimeter thereof. In various aspects, a multi-axis sensor actuator (e.g., actuator 106a) is a structure that moves or otherwise actuates the sensors(s) (e.g., multi-directional sensor 108s1 and/or multi-directional sensor 108s2). In some aspects, the multi-axis sensor actuator (e.g., actuator 106a) is a dampening structure, which may be formed of one or more areas, portions, or frame types. For example, the multi-axis sensor actuator (e.g., actuator 106a) is shown with various example portions 106ap1 and 106ap2, which may or may not form part of the multi-axis sensor actuator (e.g., actuator 106a). The additional portions 106ap1 and/or 106ap2 may be added or removed to the multi-axis sensor actuator (e.g., actuator 106a) so as to provide different force(s) across the physical structure of actuator 106a as a whole. For example, adding portion 106ap1 and/or 106ap2 can cause sensors (e.g., multi-directional sensor 108s1 and/or multi-directional sensor 108s2) to experience additional force when the force is transferred from bumper 104 (after striking an object) across portion(s) 106ap1 and/or 106ap2 to respective actuator receiver 106ar1 and/or actuator receiver 106ar2, and ultimately to respective sensors (e.g., multi-directional multi-sensor 108s1 and/or multi-directional sensor 108s2) for generation of corresponding sensor data.

Still further, the material properties of the multi-axis sensor actuator (e.g., actuator 106a) and/or its portions(s) 106ap1 and/or 106ap2 may impact or otherwise influence the amount or degree of force, and thus, amount or degree of sensor data, generated by the sensor(s). That is, in various aspects the multi-axis sensor actuator 106a (and/or portions thereof) may be configured to be deformed in a shape such that a deformation of the shape can create a change in sensor data as output by at least one sensor (e.g., multi-directional sensor 108s1 and/or multi-directional sensor 108s2). For example, a dampening effect of a given dampening structure come from the physical material (e.g., plastic) of the multi-axis sensor actuator itself where the property of plastic(s) and the deformation behavior of plastics in general may, at least in some aspects, provide dampening and/or elasticity. It is to be understood that the multi-axis sensor actuator need not be perfectly elastic. In various aspects, the multi-axis sensor actuator can be rigid or flexible. Additionally, or alternatively, the multi-axis sensor actuator (e.g., actuator 106a) can be linear or non-linear with respect to flexibility, but at the same time be configured to actuate one or more sensor(s). For example, the multi-axis sensor actuator (e.g., actuator 106a) as a dampening structure may be coupled to multi-directional sensor 108s1 and second multi-directional sensor 108s2 but be configured to be sufficiently rigid to move multi-directional sensor 108s1 and/or multi-directional sensor 108s2 when a force is applied to the multi-axis sensor actuator (e.g., actuator 106a). Such force may comprise when at least a portion of the outer perimeter (e.g., outer perimeter 102op) of body 102 of robot 100 contacts an object (e.g., obstacle 804) in the environment (e.g., environment 800). For example, in some aspects, the multi-axis sensor actuator (e.g., actuator 106a) is formed of a material (e.g., a plastic) that is sufficiently rigid to apply actuation force(s) to one or more of the sensor(s) (e.g., multi-directional sensor 108s1 and/or the second multi-directional sensor 108s2) so as to apply a degree of force in proportion to the sensor(s) in order to move, or otherwise interact with, the sensor(s) and thus cause sensor data to be generated therefrom.

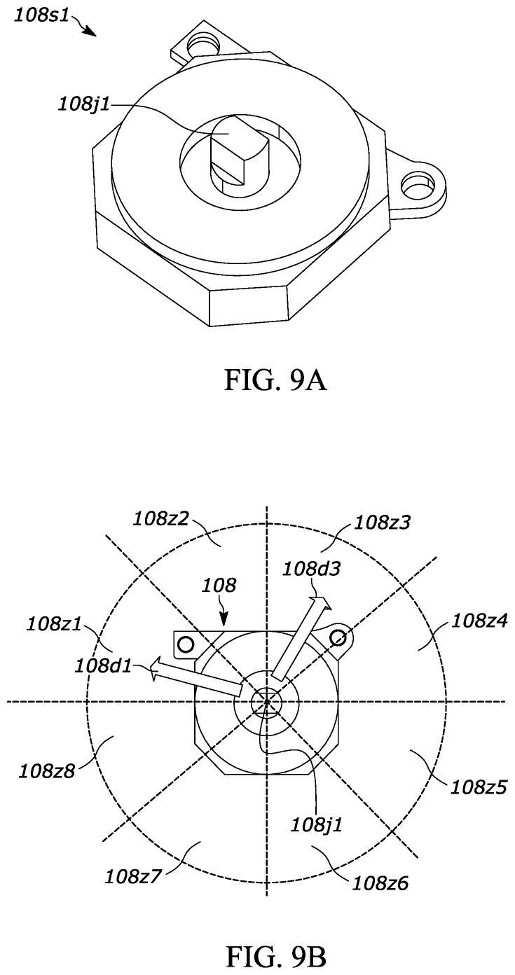

In the example of FIG. 2C, multi-directional sensor 108s1 and/or multi-directional sensor 108s2 may comprise joystick type sensors that generate respective sensor data when force is applied to a joystick (e.g., 108j1 as shown for FIG. 9A) of the sensor. For example, a joystick (e.g., joystick 108j1) of multi-directional sensor 108s1 may connect or otherwise couple to actuator receiver 106ar1, where actuator receiver 106ar1 pushes or otherwise actuates the joystick portion of multi-directional sensor 108s1 when bumper 104 hits an object in an environment (e.g., example environment 800). Actuation of the joystick sensor (or otherwise multi-directional sensor 108s1) causes the sensor to generate sensor data (e.g., in a degree proportional to the amount of travel of the joystick) that is then provided to processor 112 and/or 114 for processing, analysis, and/or storage, for example, as described herein. In some aspects, multi-directional sensor 108s2 may also be a joystick sensor that operates in as same or similar manner as described for multi-directional sensor 108s1.

In various aspects, each of the multi-axis sensor actuator (e.g., 106a), multi-directional sensor 108s1, and multi-directional sensor 108s2 together comprise or form a synthetic sensor. In such aspects, computing instructions stored on the computer memory 114, when executed by processor 112, are configured to cause processor 112 to generate synthetic sensor data based on first sensor data of as received by multi-directional sensor 108s1 and/or second sensor data as received by multi-directional sensor 108s2. For example, in some aspects, synthetic sensor data may comprise data computed and/or combined using each of the first sensor data and the second sensor data even though the sensor data and the second sensor data may differ based on at least one of direction and/or magnitude. Synthetic sensor data may be calculated, generated, or otherwise determined by averaging, taking a derivative of, taking weights of, or otherwise combining the first sensor data and the second sensor data of multi-directional sensor 108s1 and multi-directional sensor 108s2. Such data may be generated when the sensor(s) are actuated as part of multi-axis sensor actuator (e.g., 106a) when robot 100 (e.g., bumper 104) strikes an object (e.g., obstacle 804).

In addition, in some aspects multi-axis sensor actuators (e.g., actuator 106a) are configured to actuate separate sensor(s) separately or independently. For example, actuator 106a could be configured to actuate multi-directional sensor 108s1 and/or multi-directional sensor 108s2 separately or independently by disassociating or otherwise eliminating portions (e.g., actuator portion 106ap1 and/or actuator portion 106ap2) of the bumper 104. For example, in some aspects, bumper 104 may be configured to have multiple independent portions that move freely with respect to one another and thus separately actuate related sensor(s) that are coupled to respective actuator receiver(s).

Still further, additionally or alternatively, in some aspects, multi-axis sensor actuator (e.g., actuator 106a and portions thereof such as actuator portion 106ap1 and/or actuator portion 106ap2) is limited to one more directions and/or one or more distances of travel within or with respect to the body 102 of robot 100 to prevent actuating at least one of the multi-directional sensor (e.g., multi-directional sensor 108s1) or the second multi-directional sensor (e.g., multi-directional sensor 108s2) to a fully actuated position. For example, in such aspects, by preventing or avoiding actuating a multi-directional sensor to a fully actuated position, the longevity and/or operation of the multi-direction sensor, as well as its data fidelity, may be improved, thereby improving and/or prolonging the accuracy and operating efficiency of the robot itself.

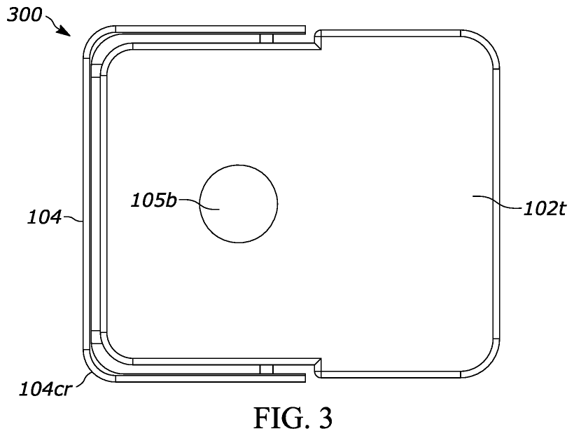

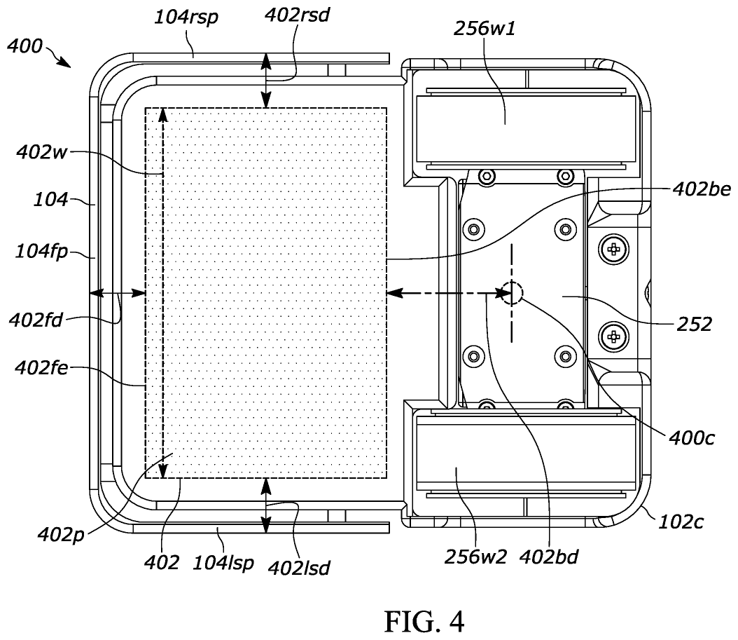

FIG. 3 illustrates a top view 300 of the example robot 100 of FIG. 1 in accordance with various aspects disclosed herein. FIG. 3 illustrates bumper 104 and top 102t of body 102 of robot 100 as viewed from above. The bumper 104 may be comprised of a corner radius (e.g., corner radius 104cr) configured to maximize, or least enlarge, an area of the cleaning element (e.g., cleaning element 402 as described for FIG. 4).

FIG. 4 illustrates a bottom view 400 of the example robot of FIG. 1 in accordance with various aspects disclosed herein. FIG. 4 illustrates bumper 104 and chassis 102c of body 102 of robot 100 as viewed from below. Further, FIG. 4 illustrates wheelbase 252 as well as wheels 256w1 and wheels 256w1 as viewed from below. Still further, FIG. 4 illustrates a cleaning element 402 that may be attached to body 102 of robot 100. Such cleaning element may comprise a substate mount (e.g., a VELCRO-based mount or a grommet-based mount) for receiving and holding a disposable hard surface wiping substate (e.g., cleaning pad 402p) to the underside of robot 100. The cleaning element 402 or substate mount may include a width (e.g., width 402w). Cleaning element 402 may be used to vacuum, sweep, disinfect, and/or apply a cleaning solution to the floor as robot 100 moves within an environment (e.g., environment 800). At least in one non-limiting example, cleaning element 402 may comprise, otherwise be configured to fit, a SWIFFER brand cleaning element or pad (e.g., as represented by cleaning pad 402p), including variants thereof, as manufactured or provided by THE PROCTER & GAMBLE COMPANY (P&G).

Still further, with respect to FIG. 4, the robot may comprise a center of rotation (e.g., center of rotation 400c). The robot may further comprise a turn radius, which can be measured based on a distance (e.g., distance 402bd) between a back edge of a portion (e.g., back edge 402be) of cleaning element 402 (e.g., the back edge cleaning pad 402p attached to or as part of cleaning element 402) and the center of rotation (e.g., center of rotation 400c).

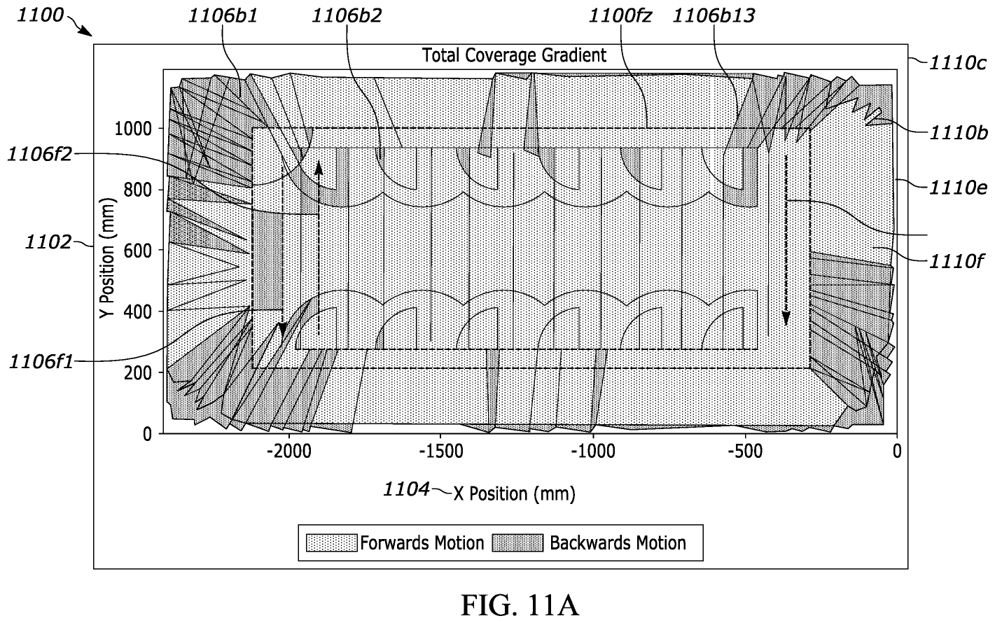

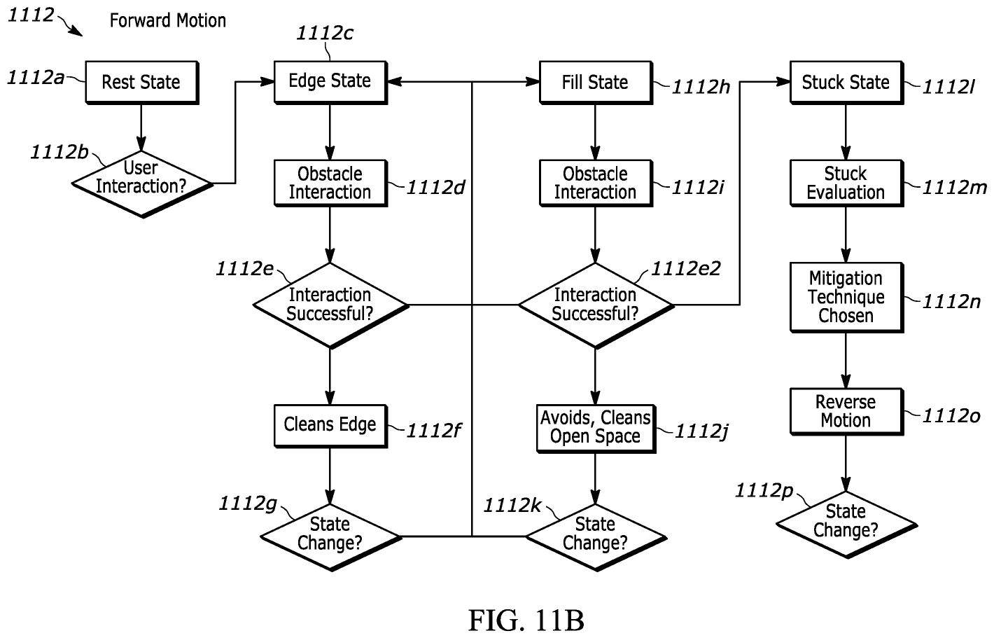

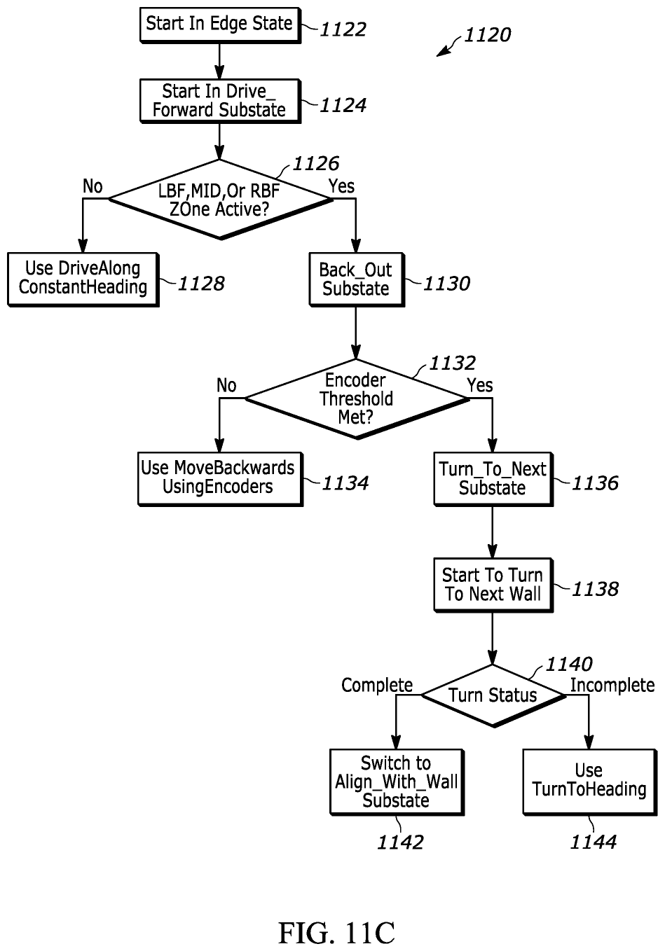

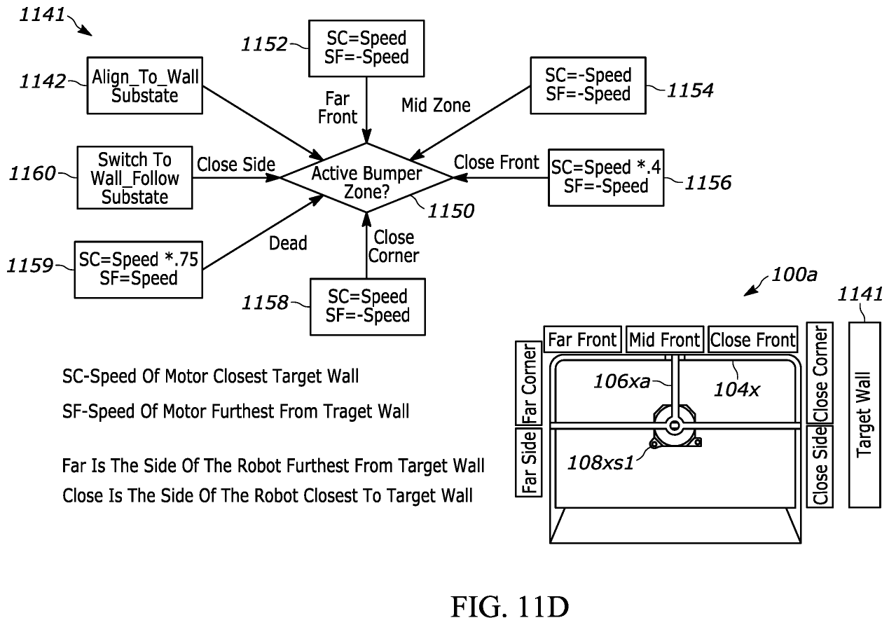

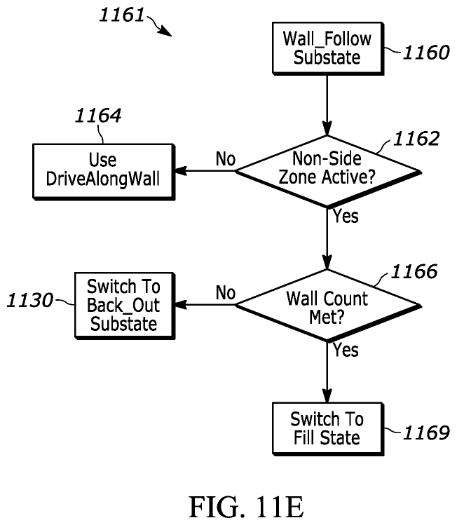

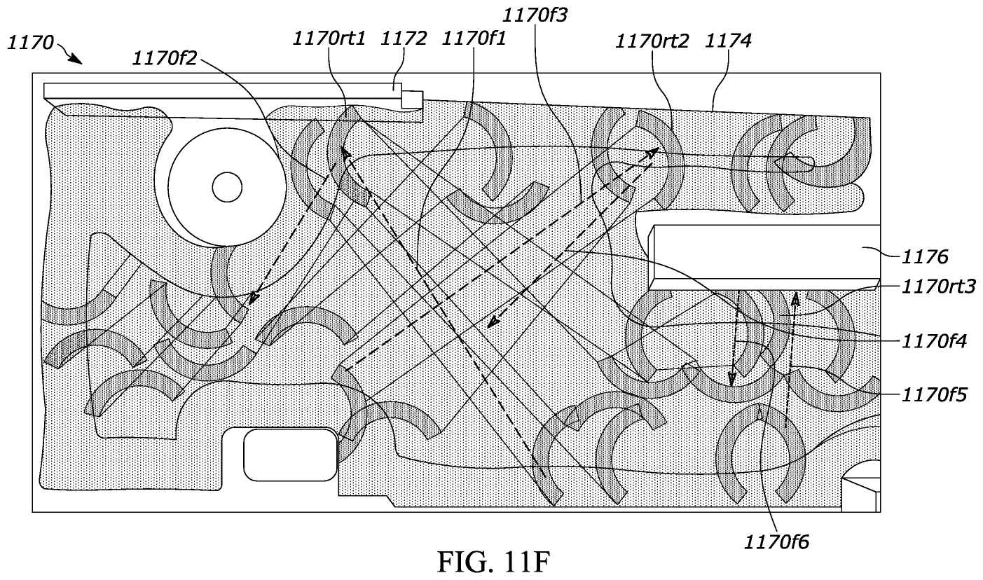

In addition, as shown for FIG. 4, bumper 104 comprises a front bumper portion 104fp, a right-side bumper portion 104rsp, and a left-side bumper portion 1041sp. It is to be understood that additional and/or different bumper portions, areas, or zones may be defined for bumper 104, e.g., for example as illustrated by FIG. 11D herein.

Further, as shown for FIG. 4, cleaning element 402, or a portion thereof (e.g., a cleaning pad) may be positioned in proximity to bumper 104. As shown, front side bumper distance 402fd is a distance between front bumper portion 104fp and a front edge 402fe of cleaning element 402, or a portion thereof (e.g., a cleaning pad). Similarly, right side bumper distance 402rsd is a distance between right bumper portion 104rsp and a right-side edge of cleaning element 402, or a portion thereof (e.g., a cleaning pad). Further, left side bumper distance 402lsd is a distance between left bumper portion 1041sp and a left-side edge of cleaning element 402, or a portion thereof (e.g., a cleaning pad).

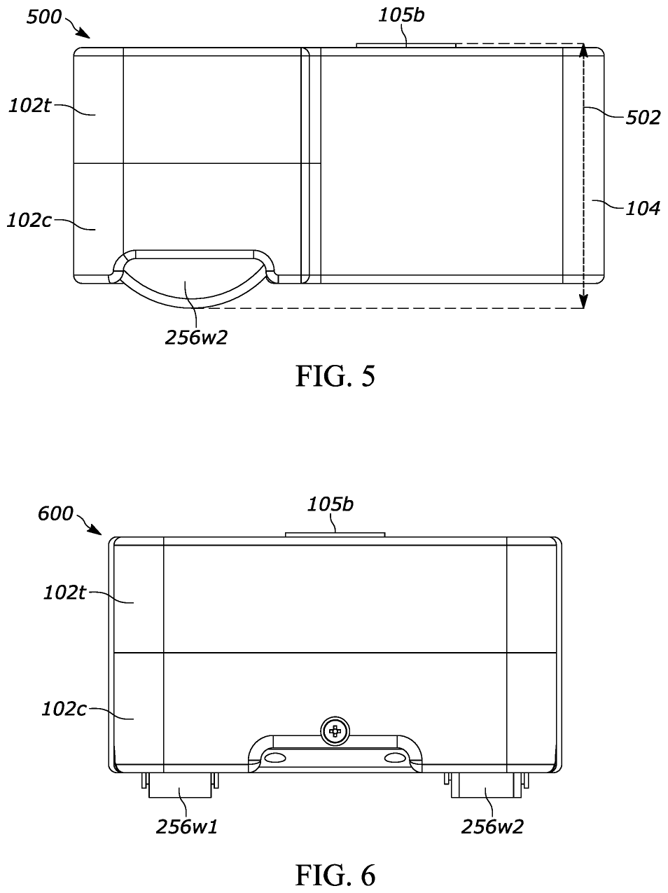

FIG. 5 illustrates a side view 500 of the example robot of FIG. 1 in accordance with various aspects disclosed herein. FIG. 5 illustrates bumper 104, chassis 102c and top 102t of body 102, and wheel 256w2 as viewed from a side of robot 100. The robot 100 may comprise a height 502, which may be measured from a bottom of a wheel (e.g., wheel 256w2) to a top portion of the robot 100.

FIG. 6 illustrates a rear view 600 of the example robot 100 of FIG. 1 in accordance with various aspects disclosed herein. FIG. 6 illustrates chassis 102c and top 102t of body 102, as well as wheels 256w1 and 256w2 as viewed from the rear of robot 100.

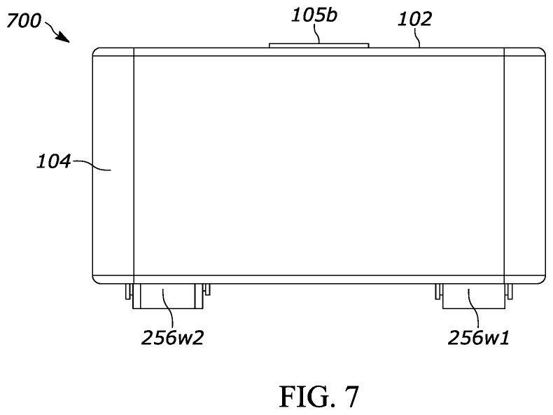

FIG. 7 illustrates a front view of the example robot 100 of FIG. 1 in accordance with various aspects disclosed herein. FIG. 7 illustrates bumper 104 as well as wheels 256w1 and 256w2 as viewed from the front of robot 100.

FIG. 8 illustrates an example environment 800 in which the robot of FIG. 1 can navigate or otherwise move within in accordance with various aspects disclosed herein. Environment 800 illustrates an example room (e.g., a living room) comprising an obstacle 804 (e.g., furniture) having two portions (e.g., legs) around which robot 100 must navigate or move. As shown in the example of figure, robot is programmed to move in linear forward back-and-forth motion to clean environment 800. As the robot encounters obstacle 804, robot 100 is able to navigate accordingly. For example, bumper 104 may come into contact with obstacle 804 (e.g., furniture) causing force to be detected by sensor(s) (e.g., multi-directional sensors 108s1 and 108s2). Sensor data may be sent to processor 112, which executes computing instructions to drive wheels of robot (e.g., wheels 256w1 and/or 256w2) to operate robot to move around or otherwise traverse obstacle 804 to allow robot 100 to continue its forward navigation, and therefore cleaning of environment 800.

### Robotic Sensor Control

FIG. 9A illustrates an example multi-directional sensor (e.g., multi-directional sensor 108s1) in accordance with various aspects disclosed herein. In the example of FIG. 9A, multi-directional sensor is an analog sensor, such as a joystick sensor. It is to be understood, that multi-directional sensor 108s1 may, in other aspects, comprise a different type of sensor, for example as described herein. As shown for FIG. 9A, multi-directional sensor (e.g., multi-directional sensor 108s1) comprises a joystick 108j1 that when moved or otherwise actuated, causes multi-directional sensor 108s1 to generate sensor data to a degree and/or magnitude associated with a distance and/or direction of travel of the joystick 108j1. For example, in various aspects, when joystick 108j1 is moved or otherwise actuated by actuator 106a through actuator receiver 106ar1, multi-directional sensor 108s1 generates sensor data. Processor 112 receives the sensor data from the multi-directional sensor 108s1. This can occur, for example, when at least a portion of the outer perimeter of the body of the robot contacts an object in an environment (e.g., environment 800). Processor 112, analyzing the sensor data, can then actuate the motor (e.g., motor 254m1 and or motor 254m2). Because the sensor data differs based on the degree of travel of the joystick (or degree of difference in the change based on the sensor type), the sensor data comprises high fidelity sensor data that can be used measure (e.g., based on the degree of travel of the joystick) various proportional degrees of contact or otherwise interactions with obstacles in the environment 800. Such high-fidelity data allows processor 112 of robot 100 to maneuver, alter its course, or otherwise operate in highly sensitive and/or highly specific manners for cleaning in small spaces, spaces having low angled areas, tight corners, or the like. The high-fidelity sensor data allows, for example, the robot to maneuver its cleaning element 402 (e.g., comprising cleaning pad) into and/or up to boundary edges (e.g., walls or otherwise edges) of an environment. At the same time, the high-fidelity sensor data allows for the robot to be operated so as to have a low impact (e.g., gentle interaction) with obstacles or walls in the environment (e.g., to avoid damaging the obstacle when it is struck by the robot). This could include, for example, precluding or mitigating damage to paint on baseboards, wood on furniture legs, etc.

Still further, in some aspects, a sensor (e.g., multi-directional sensor 108s1) may be limited to one more directions of travel and/or one or more distances of travel within or with respect to the body of the robot 100 to prevent a sensor or portion thereof (e.g., joystick 108j1) to move to a fully actuated position. That is, a joystick or otherwise high-fidelity sensor portion, may be prevented, e.g., by an actuator (e.g., actuator 106a as described herein) from traveling to the joystick's maximum physical distance. Travel to a maximum distance may place stress on the sensor or its components (e.g., springs in the joystick sensor). By preventing or avoiding actuating a multi-directional sensor to a fully actuated position, the longevity and/or operation of the sensor, as well as its data fidelity, may be improved or extended, thereby improving and/or prolonging the accuracy and operating efficiency of the robot itself.

FIG. 9B illustrates the example multi-directional sensor of FIG. 9A with an example plurality or set of radial zones (e.g., zones 108z1-108z8) in accordance with various aspects disclosed herein. Generally, sensor data may be analog or otherwise raw sensor data that does not define discrete or otherwise digital-based directions. FIG. 9B illustrates that, at least in some aspects, the sensor data may be formatted, augmented, defined or otherwise determined as directional sensor data that indicates discrete or otherwise zone-based direction(s) in which a multi-directional sensor was actuated towards or with respect to. Each radial zone can then be used to define a given direction relative to the robot 100.

As shown for FIG. 9B, multi-directional sensor 108s1 comprises eight (8) discrete zones (e.g., zones 108z1-108z8). It is to be understood, however, that additional, fewer, or different zones may also be utilized. For example, in one aspect, the plurality of radial zones may comprise at least two radial zones. Still further, in some aspects, the plurality of radial zones are configurable or otherwise adaptable to have a specified number of radial zones (e.g., 16 or 32 zones), where an increase in zones allows the sensor to report or otherwise determine a higher degree of zone activity defining the position of joystick 108j1 and thus allowing robot 100 more finite and discrete control within an environment (e.g., environment 800). Still further, in some aspects, such zones need not be uniform in size(s) and/or degree(s). Additionally, or alternatively, such zones need not be radial but can be configured to have or otherwise comprise different shapes or patterns.

When joystick 108j1 is at rest (i.e., not actuated) then a multi-directional sensor(s) can provide sensor data reporting a zero-position. In some aspects, the zero-position is set by the robot 100 when it powers on, where the robot determines an initial position of the multi-directional sensor (e.g., when at rest) as constituting the zero-position. Such procedure can be performed for each power cycle of the robot 100 (e.g., when the robot 100 is turned on and off). When 108j1 is moved in a given direction (e.g., direction 108d1) then multi-directional sensor 108s1 can provide, report, or send sensor data to processor 112 for analysis. Processor 112 can then execute its computing instructions to determine which zone the sensor data belongs to, e.g., zone 108z1 for direction 108d1. As a further example, when 108j1 is moved in direction 108d3 then multi-directional sensor 108s1 can provide, report, or send sensor data to processor 112 for analysis, where processor 112 can execute its computing instructions to determine that the sensor data belongs to zone 108z3. In this way, processor 112 can determine whether sensor data belongs to any of the given zones (e.g., zones 108z1-108z8). Such zone information and/or determination can then be used to drive or otherwise manipulate the robot 100 (e.g., by moving the robot 100 in environment 800).

Further, for each sensor, the sensor's respective sensor data can be based on the sensor's location relative to the robot 100 and/or it's body 102. For example, multi-directional sensor 108s1 may be located on a side of the robot, where processor 112 executes programming instructions that factor in multi-directional sensors 108s1's position relative to the robot 100 and/or it's body 102, in addition to other factors, such as actuator 106a's impact on multi-directional sensor 108s1 based on the position of actuator 106a (and/or its portions), the material propertie(s) of actuator 106a, and/or the direction of travel of joystick 108j1 based on such impact, configuration, structure, or otherwise setup of the overall mechanism of these components relative to multi-directional sensors 108s1.

FIGS. 10A-10C illustrates example sensors that may be used in addition to, or in the alternative to, the analog and/or joystick sensors as described for FIGS. 9A and 9B herein.

FIG. 10A illustrates an example magnetic-based multi-directional sensor configuration 1000 in accordance with various aspects disclosed herein. In the example of FIG. 10A, the multi-directional sensor is configured such that a magnet 1002m is attached to joystick 108j1 of multi-directional sensor 108s1. In such aspects, multi-directional sensor 108s1 comprises a magnetic field sensor such that one or more magnets (e.g., magnets 106m1-106m3) are positioned on the outer perimeter 102op (e.g., bumper 104) of robot 100 to provide magnetic signals. In such aspects, the magnetic field sensor (e.g., multi-directional sensor 108s1) of magnetic-based multi-directional sensor configuration 1000 generates the sensor data based on the magnetic signals provided by the one or more magnets (e.g., magnets 106m1-106m3) when an object strikes the outer perimeter 102op (e.g., bumper 104) of robot 100. For example, as shown for FIGS. 2A and 2C, magnets 106m1-106m3 are positioned on a surface (e.g., an interior surface or partially embedded surface of bumper 104) of the robot 100 to provide magnetic signals such that the magnets travel closer or further from the joystick 108j1 and magnet 1002m as bumper 104 is struck by a given object. The magnetic field sensor (e.g., multi-directional sensor 108s1) can then generate sensor data, for receipt by processor 112, based on the magnetic signals. More generally, the magnets that make up the magnetic field can be positioned on robot 100 in various locations, e.g., the magnetic field sensor could be on or in the body of the robot with the magnets on the outer perimeter 102op of the robot body (e.g., magnets on bumper 104 as illustrated for FIG. 2A), or, in the alternative, the magnetic field sensor could be on the bumper structure, with the magnets inside the robot body 102 (not shown).

FIG. 10B illustrates an example Hall-effect-based multi-directional sensor configuration 1050 in accordance with various aspects disclosed herein. As shown in FIG. 10B, a multi-directional sensor 108s1 may comprise a Hall-effect type sensor. Generally, a Hall-effect sensor (e.g., multi-directional sensor 108s1) of Hall-effect-based multi-directional sensor configuration 1050 may comprise a type of transducer configured to detect the presence or absence of a magnetic field. The magnetic field can be created by one or more magnets (e.g., magnets 106m1-106m3) that are positioned on the outer perimeter 102op (e.g., bumper 104) of robot 100 to provide magnetic multi-directional sensor 108s1 may detect the generation of a voltage difference (i.e., a Hall voltage) across a conductor or semiconductor of multi-directional sensor 108s1 when it is subjected to the magnetic field. The voltage is proportional to the strength of the magnetic field and can be measured as an output signal. The output signal may comprise (e.g., can be interpreted as, or cause to be generated) sensor data that can be provided to processor 112 for analysis and processing to move or navigate robot 100 as described herein.

FIG. 10C illustrates an example Time-of-Flight (ToF)-based multi-directional sensor configuration 1075 in accordance with various aspects disclosed herein. FIG. 10C illustrates ToF sensor 116 as a multi-directional sensor. ToF sensor 116 measures the distance between ToF sensor 116 and an object (e.g., bumper 104) by determining the time it takes for a light signal or a laser pulse to travel to the object and back to the sensor. More generally, a TOF sensor operates based on the principle of measuring the time it takes for light to travel a certain distance. A given ToF sensor will emit a light signal, such as a laser pulse or an infrared beam, and then measure the time it takes for the signal to be reflected back to the sensor. By using the known value of the speed of light, a ToF sensor (e.g., ToF sensor 116) can calculate the distance to the object. ToF sensor 116 can then use the information regarding the reflected light to generate 3D sensor data defining the object that the light was reflected off of.

As shown for FIG. 10C, multi-directional sensor 116 is configured to send and receive signals (e.g., such as light represented by field of view cone) to an interior surface of robot 100 (e.g., bumper 104). The surface (e.g., bumper 104) may change angles or otherwise be deformed when it comes into contact with an object (e.g., obstacle 804) of an environment (e.g., environment 800). For example, surface 104t1 represents a surface of bumper 104 at a first time and surface 104t2 represents a surface of bumper 104 at a second time when bumper 104 is being moved or otherwise deformed when robot 100 strikes an object (e.g., obstacle 804). The ToF sensor 116 can detect light bounced off bumper 104 and generate 3D sensor data associated with the amount and direction of the movement or deformation of bumper 104. Such 3D sensor data can then be provided to processor 112 for processing and/or analysis described herein. That is, in some aspects, sensor data comprises three-dimensional (3D) sensor data as detected and generated by a ToF sensor (e.g., ToF sensor 116) of one or more interior surfaces of the body of the robot (e.g., one or more interior surfaces of bumper 104). In such aspects, the 3D sensor data can define a distance of the one or more interior surfaces of the body of the robot with respect to the ToF sensor that processor 112 can use to determine an impact or movement of the given surface area, and then move or navigate robot 100 in response thereto.

### Robot Navigation Strategy

Robotic cleaning may comprise navigation strategies implemented by a robot (e.g., robot 100) executing algorithms or computing instructions stored in its memory (e.g., memory 114). In various aspects, a robot configured for cleaning and/or navigation comprises a body (e.g., robot body 102) having a chassis (e.g., chassis 102c) and a cleaning element (e.g., cleaning element 402). The robot may comprise a motor (e.g., motor 254m1 and/or motor 254m2) configured to move the robot (e.g., robot 100) within an environment (e.g., environment 800).

The robot may further comprise a sensor. The sensor may include a force-based sensor (e.g., an analog sensor or a joystick sensor as described herein for FIG. 9A and/or 10A). However, it is to be understood, that the sensor may comprise a different sensor type including, by way of non-limiting example, a magnetic-based sensor (e.g., a magnetic field or Hall-effect sensor as described herein for FIGS. 10A and 10B). Additionally, or alternately, the sensor may comprise an image-based sensor or light-based sensor (e.g., ToF sensor 116) as described herein for FIG. 10C.

The robot may further comprise a processor (e.g., processor 112) communicatively coupled to the sensor and a computer memory (e.g., memory 114) communicatively coupled to the processor. The computing instructions, when executed by the processor (e.g., processor 112), may cause the processor to navigate or alter the course of the robot within the environment (e.g., environment 800), for example, as described herein for FIGS. 11A-13. The maneuvering, altering of course, or otherwise navigation strategy increases cleaning efficiency by minimizing particle drop (i.e., debris falloff) because the robot is configured to maintain or maximize a forward movement or forward moving direction. The forward movement or forward moving direction allows the cleaning element 402 (e.g., its cleaning pad) to capture and push debris in a continuous direction so as to hold the debris in the pad (e.g. cleaning pad 402p). Similarly, the navigation strategy minimizes any reverse movement or reverse direction in order to prevent or minimize backing up or reversing direction, which can cause the cleaning element 402 (e.g., comprising its cleaning pad 402p) to experience debris falloff or particle drop.

FIG. 11A illustrates a coverage diagram 1100 showing example navigation or movement of a robot (e.g., robot 100) within an environment in accordance with various aspects disclosed herein. In particular, FIG. 11A shows coverage plot or diagram showing a path that a robot (e.g., robot 100) moved or navigated within a given environment. For example, the environment may comprise or represent a top-down view of environment 800. In various aspects, including in the example of FIG. 11A, the robot (e.g., robot 100) operates in different modes related to cleaning different areas of an environment 800. For example, a robot (e.g., robot 100) may operate to clean one or more edge(s) (e.g., walls) of an environment 800 as demonstrated, for example, by forward movement 1110f. As a further example, a robot (e.g., robot 100) may operate to clean a fill zone 1100fz, which may comprise a non-edge area of an environment (e.g., a center or middle area of an environment 800), which may be represented, for example, by areas shown for forward movements of the robot (e.g., forward movements 1106f1-1106f13).

In the example of FIG. 11A, the environment is defined or mapped according to a Y-Position 1102 and an X-Position 1104 defining the robot's movement within the environment 800. The positions are measured in millimeters (mm), although it is to be understood that different position values and/or measurements may be used to identify a robot's position within a given environment.

As demonstrated in the example of FIG. 11A, robot 100 moves, at least in one aspect, in a zig-zag type pattern, or, otherwise back-and-forth type pattern comprising forward movement 1106f1, forward movement 1106f2, and so forth including forward movement 1106f13. It is to be understood, however, that different movement patterns are contemplated herein. Each of the forward movements (e.g., forward movements 1106f1-1106f13) comprises a forward direction or otherwise forward motion relative to a cleaning element (e.g., cleaning element 402) of the robot (e.g., robot 100), where the cleaning element 402 is positioned in a front portion of the robot 100. In this way, the robot (e.g., robot 100) moves forward and thereby cleans a center or middle portion of the environment 800. FIG. 11A also shows example backward movements 1106b1, 1106b2, and 1106b13, which occurred before or after forward movements 1106f1, 1106f2, and 1106f13. That is, backward movements 1106b1-1106b13 illustrate instances at which the robot (e.g., robot 100) was moving backwards relative to its cleaning element (e.g., cleaning element 402) for example in order to implement a turning or maneuver to begin a transition from one forward movement to another (e.g., forward movement 1006f1 to 1006f2).

FIG. 11A further exemplifies a navigation or movement of a robot (e.g., robot 100) involving an edge-follow or otherwise wall-follow algorithm. This is illustrated, for example, by forward movement 1110f and backward movement 1110b. As shown for FIG. 11A, robot 100 follows an edge 1110e edge (e.g., a baseboard or otherwise wall or obstacle) of the environment (e.g., environment 800). Robot 100 moves in a forward direction (e.g., forward movement 1110f) relative to its cleaning element (e.g., cleaning element 402) thereby cleaning near or along 1110e edge (e.g., a wall). When robot 100 approaches corner 1110c (e.g., a corner of the environment such as two adjoining walls), then robot 100 engages or implements backward movement 1110b in order to rotate or otherwise alter its direction to continue moving in a forward direction (x-position direction) relative to the wall. In this way, robot 100 can clean a perimeter of the environment along one or more edges to ensure cleaning, disinfecting, or otherwise improvement occurs not only with respect to the center of the environment (e.g., forward movements 1106f1-1106f13), but also with respect to the edges of the environment (e.g., environment 800).

In order to accomplish the forward and/or backward movements (e.g., forward movements 1106f1-1106f12 and 1100f, backward movements 1106b1-1106b13 and 1110b) as illustrated for FIG. 11A, processor 112 of robot 100 executes computing instructions, stored in memory 114. The computing instructions, when executed, cause processor 112 to actuate a motor (e.g., motor 254m1 and/or motor 254m2) to drive the robot 100 in a forward direction (e.g., forward movements 1106f1-1106f12 and 1100f) relative to the cleaning element (e.g., cleaning element 402). Further, the computing instructions, when executed, cause processor 112 to receive sensor data from a sensor (e.g., multi-directional sensor 108s1 and/or multi-directional sensor 108s2). The sensor data may indicate an object in the environment (e.g., environment 800) relative to the robot 100, for example, when the robot 100 strikes or other interacts with an obstacle 804, such as furniture or a wall within the environment. Still further, the computing instructions, when executed, cause processor 112 to actuate the motor (e.g., motor 254m1 and/or motor 254m2) based on the sensor data to cause the robot (e.g., robot 100) to alter its course while maintaining the forward direction relative to the cleaning element (e.g., cleaning element 402). Thus, the robot 100 can experience an increased amount of forward movement compared to backward movement (e.g., backward movements 1106b1-1106b13 and 1110b).

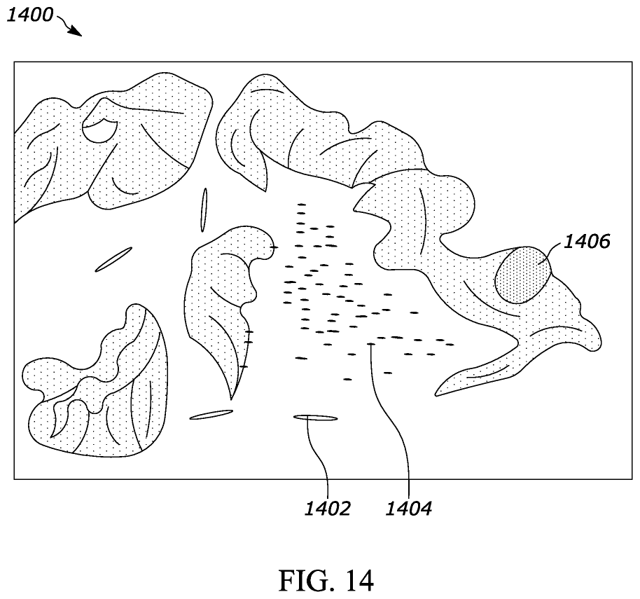

In this way, the cleaning element 402 is able to hold or otherwise collect debris as the robot 100 moves. In particular, in such aspects, robot 100 moving the cleaning element 402 is configured to hold or collect debris 1406 (e.g., as illustrated for FIG. 14) as the robot 100 moves in the forward direction (e.g., forward movements 1106f1-1106f12 and 1100f). By contrast, robot 100 may experience debris loss or falloff when it moves in a backward direction (e.g., backward movements 1106b1-1106b13 and 1110b). Thus, an algorithm implemented by processor 112 seeks to maximize debris 1406 retention and collection by maximizing a total forward amount that robot 100 experiences for any given cleaning session. For example, at least in some aspects, robot 100, when moving the cleaning element 402 in a given environment (e.g., environment 800) is configured to hold or collect at least 90 percent of a total amount of debris 1406 acquired or otherwise experienced by the cleaning element (e.g., cleaning element 402) as the robot moves in the forward direction. The given total amount of debris can be an amount of debris that is acquired or otherwise experienced by the robot during a cleaning session of the robot. A cleaning session may comprise, by way of non-limiting example, a duty cycle of the robot, a time to clean a given environment (e.g., a room), and/or a given period of time of cleaning (e.g., 10 minutes, 15 minutes, or some other unit time of cleaning).

FIG. 11B illustrates a flowchart for navigation algorithm 1112 in accordance with various aspects disclosed herein. Navigation algorithm 1112 may be implemented to maximize a total forward amount that robot 100 experiences for any given cleaning session, for example, as described for FIG. 11A or otherwise herein. The algorithm 1112 may comprise programming instructions (e.g., JAVA or C++ instructions) stored in memory 114 and selected (e.g., by a user or automatically chosen by the processor 112) to be executed by processor 112 to implement the functionality as shown for FIGS. 11A-11E herein.

For example, as shown for FIG. 11B, navigation algorithm 1112 begins in a rest state 1112a (e.g., where robot 100 is turned off, is charging, or is otherwise in a low power mode). At block 1112b, processor 112 determines whether user interaction occurred (e.g., via activation of the robot via a switch (e.g., switch 105s), button (e.g., button 105b), or other means for activating the robot 100). At block 1112c, activation by the user causes robot 100 to enter edge state, which causes robot to clean an edge of an environment (e.g., as described for FIG. 11C or elsewhere herein). At block 1112h, robot 100 may enter a Fill State (as described herein for FIG. 11E). In the alternative, at block 1112d, robot 100 performs obstacle interaction (e.g., by detecting an obstacle collision via its bumper 104 and corresponding sensor(s) (e.g., multi-directional sensor 108s1). At block 1112e, if the robot 100 can continue (not in a stuck state), then robot 100 continues to clean the edge (block 1112f). Robot continues to monitor for state changes (block 1112g). For example, robot 100 may enter a Fill State (block 1112h) causing the robot 100 to clean a center or middle area of the environment. At block 1112i, robot 100 performs obstacle interaction (e.g., by detecting an obstacle collision via its bumper 104 and corresponding sensor(s) (e.g., multi-directional sensor 108s1). At block 1112j, if the robot 100 can continue (where obstacle interaction was successful 1112e2, e.g., not in a stuck state), then robot 100 continues to clean the center or otherwise open space of an environment (block 1112k). Robot 100 continues to monitor for state changes (block 1112k).

In some cases, robot 100 will enter a stuck state (1112l). The stuck state may be determined by an inertial measurement unit (IMU) sensor as described herein. The (IMU) sensor can provide IMU sensor data to processor 112 so that processor 112 can perform a stuck evaluation (block 1112m). The stuck evaluation (block 1112m) can comprise determining a tilt, in three-dimensional space, of the robot. For example, the stuck evaluation (block 1112m) may comprise processor 112 determining whether a front edge of the robot is on top an object (e.g., a vent) that the robot has maneuvered onto. More generally, the stuck evaluation (block 1112m) can comprise choosing a mitigation technique (1112n) that comprises determining a location of the robot 100 and its body 102 relative to its wheels (e.g., 256w1, 256w2) to determine how to actuate its motor(s) (e.g., motor 254m1) to alleviate the stuck state (e.g., cause the robot to become unstuck). In some cases this requires a reverse motion (block 1112o), where the robot must move in a rearward direction to become unstuck. The reverse motion may be minimized so as to maximize the forward direction of travel, and thus avoid debris falloff as described herein. This may include a tiered fallback procedure where the robot attempts to minimize reversing (with small increments of reverse motion) followed by repeated attempts at forward motion until the robot becomes unstock. In any event, once the mitigation and/or reversing is complete, robot 100 will again attempt to determine its state (block 1112p), where the algorithm of the robot 100 will continue to loop as the robot 100 navigates and cleans the environment.

FIG. 11C illustrates a flowchart for edge navigation algorithm 1120 in accordance with various aspects disclosed herein. In the example of navigation algorithm 1120, FIGS. 11C-11E refer to robot 100a (as shown for FIG. 11D). It is to be understood, however, that, in addition to or in alternative to robot 100a, robot 100 (or other robot in accordance with the disclosure herein) could also perform the navigation algorithm 1120 as described herein. With reference to FIG. 11D, robot 100a comprises the same or similar components as robot 100 but where robot 100a has a single sensor 108xs1, an actuator 106xa configured to provide force to sensor 108xs1, wherein the force may be generated by an obstacle striking bumper 104x of robot 100a. Bumper 104x has several zones categorized relative to target wall 1141 against which robot 100a may move against, parallel to, or otherwise with respect to. As shown for FIG. 11D, bumper 104x includes the following zones: far side zone (a side zone farthest from target wall 1141), far corner zone (a corner zone farthest from target wall 1141), far front zone (a frontal zone far from target wall 1141), mid front zone (a frontal zone center relative to target wall 1141), close front zone (a frontal zone close to target wall 1141), close corner zone (a corner zone closest to target wall 1141), and close side zone (a side zone closest to target wall 1141). It is to be understood, however, that additional, fewer, or different zones could be defined for bumper 104x (or bumper 104). Zones are defined by any one or more of a given sensor or set of sensors, the sensor(s) position(s) relative to the bumper and the attachment thereto by a given actuator, and/or how and what degree the sensor data is received and processed by processor 112. By using one or more of these attributes or features, processor 112 can determine which zone of a given bumper was struck or hit.

With reference to FIG. 11C, navigation algorithm 1120 comprises a state diagram, where a robot (e.g., robot 100a) operates according to various states that may change causing the robot (e.g., robot 100a) to navigate or otherwise move within an environment (e.g., environment 800) in various directions or manners. In various aspects, navigation algorithm 1120 illustrates an algorithm, as executed or implemented by processor 112, for implementing a robot's (e.g., robot's 100a) movement as described herein (e.g., for any FIG. 11A, 12A, or 13) or otherwise as described herein. Navigation algorithm 1120 comprises a block diagram or flowchart that shows states and computing functions (e.g., substates) that may be executed by processor 112 based on a current state of a robot. In various aspects, the computing instructions, as stored in memory 114, may comprise the computing functions (e.g., substates), where, for example, the computing functions (e.g., substates) are implemented or executed by processor 112 as part of the computing instructions.

As shown for FIG. 11C, navigation algorithm 1120 starts in an EDGE state 1122, which defines a movement of a robot (e.g., robot 100a) along an edge (e.g., a wall or a baseboard). The EDGE state causes execution, by processor 112, of a DRIVE_FORWARD 1124 function (substate), which may actuate a motor (e.g., motor 254m1 and/or motor 254m2) to drive the robot (e.g., robot 100a) to move in a forward direction (e.g., forward movement 1110f as shown for FIG. 11A). As the robot moves in a forward direction, processor 112 monitors for interactions with its outer perimeter outer perimeter 102op (e.g., bumper 104). The interactions can be determined based on active zones 1126 (e.g., zones of bumper 104x as described herein). If there is no interaction, then processor 112 of the robot executes a Drive AlongConstantHeading 1128 function to continue its current course.

When the robot (e.g., robot 100a) strikes an obstacle in an environment, processor 112 analyzes active zones 1126, relative to bumper 104x, to determine whether an impact occurs, and in various aspects, what zone has been impacted (e.g., any one or more of Mid Front, Far Side, Close Corner, etc. as shown, by way of non-limiting example, for robot 100a of FIG. 11D). As shown for FIG. 11C, processor 112 may then execute a BACK_OUT substate (function) 1130. BACK_OUT substate (function) 1130 may determine whether an encoder threshold is met. The BACK_OUT substate does not limit the robot to backing out in a linear manner. That is, backing out is not limited to backing out in a straight line (but may include this functionality. However, it should be understood that different backout directions, shapes, and pivoting are contemplated herein. For example, different directions or axes of backing out may occur depending on the zone that the robot struck or otherwise encountered. In some cases, the BACK_OUT substate could include a forward movement. The encoder threshold may define whether robot 100a has struck a wall (where a plurality of the front zones of bumper 104x of triggered). If not, then processor 112 may execute a MoveBackwardsUsingEncoders function 1134 to back away from a struck obstacle in the environment. Otherwise, a TURN_TO_NEXT Substate (function) 1136 may be executed by processor 112, where robot 100a starts to turn next to a wall 1138. Processor 112 may then drive one or more motors (e.g., motor 254m1 and/or motor 254m2), and continue to check a turn status 1140, until robot's 100a turn is complete. If the turn is incomplete, then processor 112 executes turnToHeading 1144 until the turn is executed. Once executed, processor 112 switches robot 100a's state and executes the ALIGN_WITH_WALL substate 1142, causing the robot 100a align its forward direction parallel to the wall.

FIG. 11D illustrates a further flowchart portion 1141 of the edge navigation algorithm 1120 of FIG. 11A in accordance with various aspects disclosed herein. Flowchart portion 1141 illustrates an algorithm for aligning a robot (e.g., robot 100a) to a second wall after striking or otherwise interacting with a first wall, where the walls may be perpendicular to each other. From implementation of ALIGN_WITH_WALL substate 1142, processor 112 rotates robot 100a by driving motor(s) (e.g., motor 254m1 and/or motor 254m1) while monitoring active bumper zones 1150. If a far front zone 1152 is detected, then a SC speed (i.e., a speed of a motor closest to target wall 1141) remains constant while a SF speed (i.e., a speed of a motor furthest from target wall 1141) is reduced (e.g., as indicated by the minus (“−”) sign) to cause robot 100a to pull its back side out, and to push its close corner side forward. If a mid-zone 1154 is detected, then both SC and SF speeds are reduced to cause robot 100a to back up. If a close front zone 1156 is detected, then both SC speed is increased (e.g., by a factor of 40%), and SF speed is reduced to cause robot 100a to pull its far wheel out slightly and push its close corner forward. If a close front zone 1156 is detected, then SC speed is increased (e.g., by a factor of 40%), and SF speed is reduced to pull the close corner forward. If a close corner zone 1158 is detected, then both SC speed is held constant and SF speed is reduced. If a dead zone 1159 (no zone) is detected, then SC speed is increased (e.g., by a factor of 75%) and SF speed is held constant to cause robot 100a to drive into the direction of the target wall. If a close side zone is detected, then processor 112 switches to implementing WALL_FOLLOW substate function 1160. At this state, the robot would be considered, for close side zone detection, to have sufficiently turned against a new wall and ready to proceed to follow along (i.e., clean along) the newly positioned wall. Alternatively, in some aspects, instead of implementing the WALL_FOLLOW substate function 1160, a different function may be executed to cause robot 100a to not follow the wall (or other object that the robot 100 has interacted with).

FIG. 11E illustrates a further flowchart portion 1161 of the edge navigation algorithm 1120 of FIG. 11A in accordance with various aspects disclosed herein. In particular, FIG. 11E illustrates implementation of WALL_FOLLOW substate function 1160. As illustrated for FIG. 11E, if no side zone 1162 (e.g., no close or far side zone) related to bumper 104x is detected or otherwise is active, as determined by the sensor data, then processor 112 implements a driveAlongWall function causing the robot, via its motor(s) (e.g., motor 254m1 and motor 254m2) to move parallel or generally laterally with respect to a wall. If a wall count 1166 is met, then processor 112 can implement or switch to the BACK_OUT substate (function). Otherwise, processor 112 will implement or switch to a FILL state 1169. The FILL state 1169 defines a state in which robot operates in a middle or a center of an environment (e.g., fill zone 1100fz) to clean a non-edge area of an environment (e.g., environment 800).

FIG. 11F illustrates an additional coverage diagram 1170 showing a further example navigation or movement of a robot within an environment in accordance with various aspects disclosed herein. In such aspects, computing instructions are configured, when executed by the processor 112, to actuate a motor (e.g., motor 254m1) to operate the robot in an angled pattern. In various aspects, the angled pattern comprises operating the robot at angles between 10 degrees and 60 degrees. In the example of FIG. 11A, robot 100 employs a navigation strategy that executes or otherwise employs different edge and fill states to clean a given environment (e.g., environment 800). Instead, processor 112 implements instructions causing robot 100 to operate in an angled (e.g., 45-degree) pattern that can clean an environment by operating in different movement directions or otherwise patterns to clean different areas of the environment. The navigation or movement algorithm implemented for FIG. 11F is, at least in some aspects, an alternative or different algorithm that the robot (e.g., robot 100), via its processor 112, may be configured to implement compared to the algorithm shown and described for FIG. 11A-11E. For example, the algorithm implemented for FIG. 11F may comprise programming instructions (e.g., JAVA or C++ instructions) stored in memory 114 and selected (e.g., by a user manually or automatically by the processor 112) to be executed instead of the algorithms shown and described for FIGS. 11A-11E.

As shown for FIG. 11F, robot 100 moves in an angled pattern, where, when the robot strikes an obstacle it changes its direction in an angular modality. For example, robot 100 moves with forward movement 1170f1 and strikes wall 1172. Robot 100, at the time its edge 1170rt1 strikes wall 1172, changes its direction in by a roughly 45-degree angle moving away from wall 1172 in new angular direction with forward movement 1170f2. That is, in such aspects, the angled pattern comprises a first forward movement (e.g., forward movement 1170f1) and a second forward movement (e.g., forward movement 1170f2) where the first forward movement is not parallel and not generally parallel to the second forward movement. As another example, robot 100 moves with forward movement 1170f3 and strikes wall 1174. Robot 100, at the time its edge 1170rt2 strikes wall 1174, changes its direction in by a roughly 10-degree angle moving away from wall 1174 in new angular direction with forward movement 1170f4. As still further example, robot 100 moves with forward movement 1170f5 and strikes wall 1176. Robot 100, at the time its edge 1170rt3 strikes wall 1176, changes its direction such that it moves or turns in a new angular direction with forward movement 1170f6, which is parallel or substantially parallel away from wall 1176 with respect to forward movement 1170f5. That is, in such aspects, the angled pattern comprises a first forward movement (e.g., forward movement 1170f5) and a second forward movement (e.g., forward movement 1170f6) where the first forward movement is parallel or generally parallel to the second forward movement. By way of non-limiting example, generally parallel can mean that the first forward movement and the second movement deviate by less than a 5 degree angle with respect to one another. In these ways, robot 100 is able to maintain its forward movement and avoid debris falloff as described herein. In addition, by implementing this algorithm, an environment may be cleaned without the need for the robot to implement multiple cleaning states that target specific zones or areas of the environment.

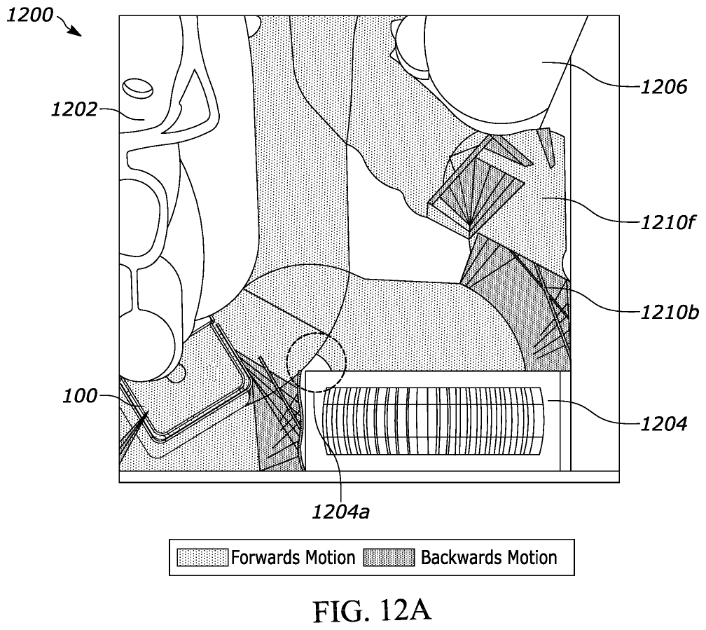

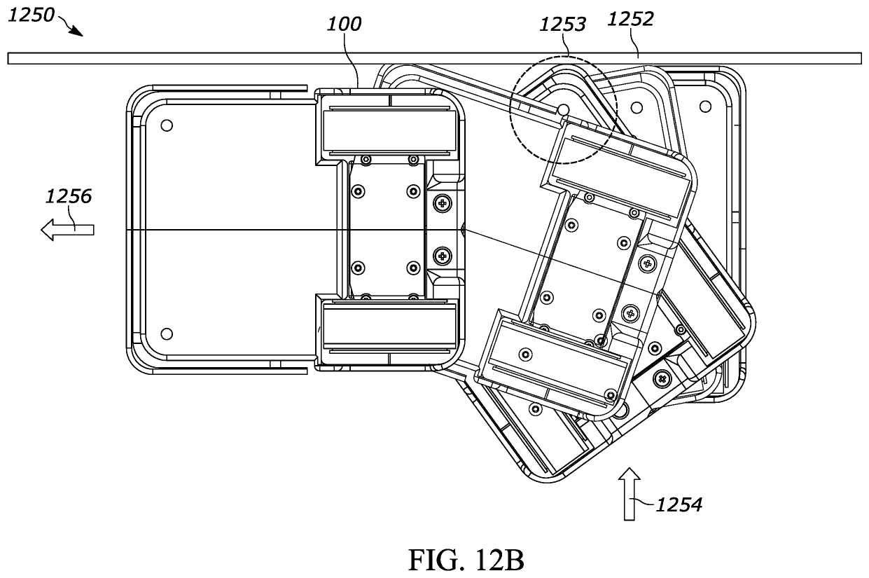

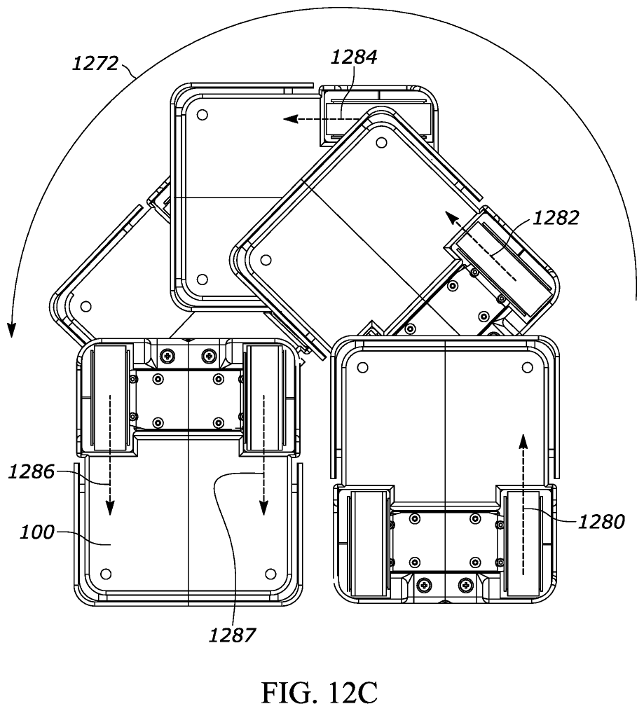

FIG. 12A illustrates example navigation or movement of a robot (e.g., robot 100) within an environment (e.g., environment 1200) in accordance with various aspects disclosed herein. In the example of FIG. 12A, environment 1200 is bathroom comprising several obstacles including, by non-limiting example, toilet 1202, vent 1204, and trashcan 1206. As shown for FIG. 12A, robot 100 is configured to minimize debris falloff (e.g., where debris falls off or away from cleaning element 402) by implementing a forward direction navigation strategy shown, for example, by forward movement 1210f. Forward movement (as for forward movement 1210f) is similarly shaded in FIG. 12A to show robot 100's navigation strategy that involves forward direction within environment 1200. In one example aspect, processor 112 may execute computing instructions (e.g., as stored in memory 114) to stop or lock one or more wheels (e.g., wheel 256w1 and/or wheel 256w2) of the robot upon receipt of sensor data from the sensor (e.g., multi-directional sensor 108s1) indicating that a collision by the robot with an obstacle (e.g., obstacle 804) is occurring.

Similarly, FIG. 12A shows that robot 100's navigation strategy for minimizing debris falloff involves minimal backward movement 1210b, which can result in debris loss. Backward movement (as for backward movement 1210b) is similarly shaded in FIG. 12A to show robot 100's navigation strategy that involves backward direction within environment 1200. As shown, robot 100 is able to navigate among, between, around, and behind each of the obstacles, including, for example, toilet 1202, vent 1204, and trashcan 1206 with minimal backward direction (e.g., backward movement 1210b) thereby avoiding debris falloff or otherwise debris loss by continuing to push the debris in a forward direction. In one example aspect, processor 112 may execute computing instructions (e.g., as stored in memory 114) to reverse, e.g., by a minimal degree, one or more wheels (e.g., wheel 256w1 and/or wheel 256w2) of the robot upon receipt of sensor data from the sensor (e.g., multi-directional sensor 108s1) indicating that a collision by the robot with an obstacle (e.g., obstacle 804) is occurring. In addition, the robot's size and/or maneuverability (e.g., turn radius) allow for the robot to cover high percentage areas of the environment, particularly complex environments. As shown, even when contacting or otherwise sensing vent 1204, only a small area 1204a is not covered due to robot's small turning radius, maneuverability, and/or otherwise navigation implementation or strategy.

In various aspects, memory 114 may store a motion profile defining motion behavior of the robot. The computing instructions may be configured, when executed by the processor 112, to access the motion profile and adapt or otherwise configure the robot's operation to reduce debris falloff from the cleaning element upon obstacle interaction with the robot. Such configuration may comprise, by way of non-limiting example, changing the speed of impact of the robot by updating the speed of a motor (e.g., motor 254m1 and/or motor 254m2). For example, a reduction or deceleration of the speed may reduce the intensity of impact of the robot 100 with an obstacle in the environment thereby decrease debris falloff. In some aspects, the motion profile may be adjusted in order to have speed increased or decreased in order to increase or decrease the force(s) and/or direction(s) of impact experienced by robot 100, e.g., via its bumper 104. For example, the motion profile may include setting a maximum negative acceleration value (e.g., deceleration value) of the robot to 33.30 millimeters (mm) per second/per second or less (but greater than zero) to prevent or reduce debris falloff. Additionally, or alternatively, the motion profile may include setting a maximum acceleration value of the robot to 9.77 millimeters (mm) per second/per second or less to prevent or reduce debris falloff. These settings may cause processor 112 to drive or actuate motor(s) motor 254m1 and/or motor 254m2 so as not to exceed these maximum values. The values are low enough to prevent debris falloff when the robot collides with an obstacle in the environment.

As another example, the computing instructions may be further configured, when executed by the processor 112, to access the motion profile and adapt or otherwise configure the robot 100's operation to reacquire, recapture, or recollect dropped debris after obstacle interaction. For example, a sensor (e.g., multi-directional sensor 108s1 and/or multi-directional sensor 108s2) may send sensor data to processor 112, where processor 112 may determine that an impact event is occurring or has occurred (e.g., that bumper is moving or has moved) based on analysis of the sensor data. The processor 112, may then access the motion profile and execute instructions to cause the robot 100, via its motor(s) (e.g., motor 254m1 and/or motor 254m2) to drive across an impact area in forward direction in order for the cleaning element (e.g., cleaning element 402) to recapture any debris falloff or particles. In some aspects, the motion profile may be adjusted in order to have the recapture navigation strategy occur only for specific force(s) or direction(s) of impact experienced by robot 100, e.g., via its bumper 104.

FIG. 12B illustrates example navigation or movement of a robot (e.g., robot 100) to reacquire, recapture, or recollect debris after interaction with an obstacle. Robot 100 is shown at various times cleaning an environment (1250), which may be the same environment as FIG. 12A. In the example of FIG. 12B, robot 100 moves with a forward movement 1254 and its bumper (e.g., bumper 104) collides with wall 152. The processor 112, may then access the motion profile and execute instructions to cause the robot, via its motor(s) (e.g., motor 254m1 and/or motor 254m2) to drive across an impact area 1253 (e.g., at or near wall 1252) in forward direction in order for the cleaning element (e.g., cleaning element 402) to recapture any debris falloff or particles caused by collision with wall 1252. The robot 100 may alter its course continuing with a forward movement 1256 along an edge of wall 1252. In this way, processor 112, executing or accessing the motion profile can implement immediate particle recapture or recollect after a bump with an obstacle (e.g., a wall) in the environment (e.g., environment 1250). In this way, impact area 1253 or otherwise area in front of the robot 100 where reversing may have occurred, is subsequently moved in a forward direction to cause debris recapture as the robot 100 moves into forward movement 1256.

As an additional example, the computing instructions may be configured, when executed by the processor 112, to access the motion profile and adapt or otherwise the robot's operation to rotate in order to prevent debris falloff from the cleaning element. For example, processor 112 may access motion profile to define how much robot 100 is able to turn or spin in order to reduce or prevent debris falloff from robot 100's cleaning element 402. In some aspects, the motion profile may be adjusted in order to have the rotation, turning, or otherwise spin of robot 100 occur only for only specific degrees or angles in order to eliminate or prevent debris falloff of cleaning element (e.g., cleaning element 402).

FIG. 12C illustrates example navigation or movement of a robot (e.g., robot 100) to minimize or prevent debris falloff when the robot is turning. For example, as shown for FIG. 12C, robot 100 turns in an arcing pattern 1272, where turning is achieved by the processor 112 actuating motor(s) motor 254m1 and/or motor 254m2, and therefore varying wheel speed differential(s) with speeds, while remaining the robot's forward movement in the positive direction (no reversing). For example as shown, the robot is able to perform a 180 degree turn (e.g., arc pattern 1272) where processor 112 actuates a motor associated with a wheel in a forward direction 1280 and by locking (or keeping still) the wheel on the opposite side. Further, processor 112 continues to actuate the motor associated with wheel in forward directions 1282 and 1284, respectively, and keeps locked (or keeps still) the wheel on the opposite side. In some aspects, the wheel on the opposite side is not locked, but kept at a reduced speed compared to the forward direction(s) 1282 and 1284 such that the robot turns in the direction of arcing pattern 1272. Finally, when the robot has turned sufficiently (e.g., 180 degrees in the example of FIG. 12C), both wheels can be set to have an equal speed (e.g., forward direction 1286 and 1287) to thereby drive the robot in a forward direction. In this way, the motion profile for turning prevents debris falloff because the robot maintains its forward movement and minimizes or prevents reversing while turning.

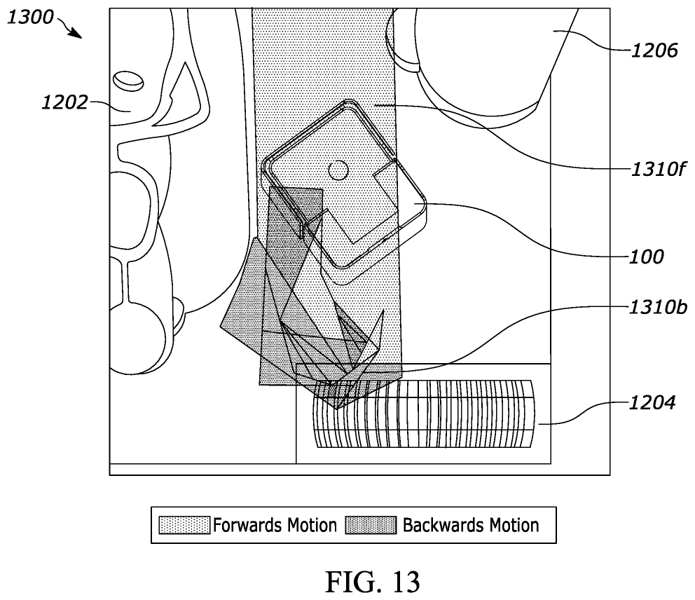

FIG. 13 illustrates an example navigation or movement of a robot (e.g., robot 100) within an environment (e.g., environment 1300) in accordance with various aspects disclosed herein. In the example of FIG. 13, environment 1300 is the same as environment 1200 of FIG. 12A, where environment 1300 comprises a bathroom comprising several obstacles including, by non-limiting example, toilet 1202, vent 1204, and trashcan 1206. As shown for FIG. 13, robot 100 is configured to minimize debris falloff (e.g., where debris falls off or away from cleaning element 402) by implementing a forward direction navigation strategy shown, for example, by forward movement 1310f. Forward movement (as for forward movement 1310f) is similarly shaded in FIG. 13 to show robot 100's navigation strategy that involves forward direction within environment 1300. Similarly, FIG. 13 shows that robot 100's navigation strategy for minimizing debris falloff involves minimal backward movement 1310b, which can result in debris loss. Backward movement (as for backward movement 1310b) is similarly shaded in FIG. 13 to show robot 100's navigation strategy that involves backward direction within environment 1200. As shown, robot 100 is able to navigate among, between, around, and behind each of the obstacles toilet 1202, vent 1204, and trashcan 1206 while allowing some backward direction (e.g., backward movement 1210b), but also avoiding debris falloff or otherwise debris loss by continuing to push the debris in a forward direction. In the example of FIG. 13 robot 100 is configured to move its cleaning element (e.g., cleaning element 402) to hold or collect at least 60 percent of a total amount of debris acquired or otherwise experienced by the cleaning element as the robot moves in the forward direction, e.g., a forward direction relevant to the cleaning element (e.g., cleaning element 402).

In some aspects, a total amount of forward direction could be compared to a total amount of backward travel to determine a total distance traveled, from which a percentage of forward and/or backward movement or travel can be determined. Processor 112, executing computing instructions, may control the amount of backward movement allowed. For example, processor 112, implementing instructions stored on memory 114, may cause the processor 112 to actuate a motor (e.g., motor 254m1 and/or motor 254m2) based on the sensor data (e.g., as collected by a sensor such as multi-directional sensor 108s1) to cause the robot (e.g., robot 100) to, prior to altering its course, move in a backward direction relative to the cleaning element (e.g., cleaning element 402). In some aspects, such backward motion may be limited to prevent robot 100 from experiencing excessive backward movement. For example, in some aspects an amount of distance traveled in the backward direction (e.g., backward movement 1310b) is set at no more than 10% of a total distance the robot traveled in the forward direction, for example, during a cleaning session. A cleaning session may comprise a range of time during which the robot cleans a given area, room, or otherwise environment. Similarly, in some aspects, the robot 100 may clean the environment (e.g., environment 800) during a cleaning session where the cleaning session comprises a plurality of time periods. For example, in some aspects, a time period may be defined towards an end of a cleaning session (e.g., a third-to-last or second-to-last time period of the cleaning session). In such aspects, a time period toward the end of the cleaning session may comprise a lower percentage of backward direction (e.g., 5% of backward direction) as traveled by the robot compared to a first time period of the cleaning session (e.g., 20% backward direction). Additionally, or alternatively, in such aspects a final period at the end of the cleaning session may be defined. In such aspects, the final period may include no backward direction (e.g., 0% backward direction) as traveled by the robot. Limiting the backward direction traveled by the robot at the final or end time period(s) reduces debris fall-off that the robot would not have an opportunity to recapture during future passes or forward movements, thus, providing an overall cleaning session where the robot can, at some point, negate any backward movement made earlier in a cleaning session with a corresponding forward movement in order to recapture any debris fall-off during the cleaning session.

Still further, additionally or alternatively, processor 112, executing computing instructions, may be configured to detect when the robot (e.g., robot 100) is in a stuck state. The stuck state could be determined based on sensor data received at processor 112, where processor 112 can actuate a motor (e.g., motor 254m1 and/or motor 254m2) based on the sensor data to cause the robot to, prior to altering its course, maneuver the robot relative to the cleaning element (e.g., cleaning element 402) to disengage from the stuck state. The stuck state (e.g., stuck state 1112l of FIG. 11B) may be based on the sensor data whereby processor 112 determines that robot 100 may longer move in one or more direction(s).

In still further aspects, additionally or alternatively, a robot (e.g., robot 100) may comprise second sensor. The second sensor may comprise comprises an inertial measurement unit (IMU) sensor. In various aspects, the IMU sensor may be placed on the body 102 of the robot in order to detect a given state, tilt, or otherwise position of the robot in three-dimensional space. The IMU sensor may be used to detect obstacles that would otherwise not come into contact with bumper 104. Such an object may comprise vent 1204 (e.g., as shown for FIG. 13), where vent 1204 may have a low enough height or profile to avoid bumping or otherwise triggering bumper 104. In such aspects, the IMU sensor may be used to detect that the robot (e.g., robot 100) has come into contact with the object even without sensor data being generated or received based on impact with bumper 104. That is, the IMU sensor may be used as a backup or additional sensor that may be used to detect objects that do not engage bumper 104. Still further, in some aspects, sensor data as received from the IMU sensor (e.g., IMU sensor data), may be formatted, transformed, or otherwise interpreted by processor 112 so as to make it compatible with sensor data, or related outputs or inputs thereof, typically generated by a different sensor or sensor type (e.g., multi-directional sensor 108s1) associated with bumper 104. In this way, the computing instructions can receive data (or related inputs) in a uniform format or otherwise type, allowing the computing instructions to be simplified and stored on the robot's computer memory in a reduced manner. Said another way, the IMU sensor can detect edges without a bumper (e.g., bumper 104), and, additionally, in some aspects, the sensor data can be provided to processor 112 in a same manner as it would have been had such sensor data come from a force sensor (e.g., multi-directional sensor 108s1). The computing instructions, or otherwise computing model, may then be used to control robot in a same or similar manner. For example, in such aspects, processor 112, executing computing instructions, may be configured to receive IMU sensor data from the IMU sensor alone without receiving sensor data from the sensor. Processor 112, executing computing instructions, may further be configured to transform the IMU sensor data into a same type of data or output as for the sensor data of the sensor. Processor 112, executing computing instructions, may further be configured to provide the same type of data or output to the processor to actuate the motor to cause the robot to alter its course while maintaining the forward direction relative to the cleaning element.

FIG. 14 illustrates example debris and sizes thereof in accordance with various aspects disclosed herein. For example, as shown in FIG. 14, by non-limiting example, debris includes rice 1402, dirt 1404, and hair 1406 as distributed on a surface (e.g., a floor) of an environment (e.g., environment 800). It should be understood, however, that additional and/or different debris, such as sand, salt, and/or other debris types or sizes are contemplated herein. In various aspects, the debris captured by a cleaning element (e.g., cleaning element 402) is of a predetermined size, such as, the size of a grain of rice or a length of hair. For example, in some aspects, the size of the debris may be between approximately 5.5e-5 mm³ and 15 mm³.

### Robot Sizing and Maneuvering

In various aspects, the size, shape, or otherwise the dimensioning of the robot (e.g., robot 100) can be configured to allow the robot 100 to maneuver in various environments or spaces, including small, tight, or otherwise environments or spaces that are difficult to clean. By way of non-limiting example, such sizing and dimensioning configures the robot (e.g., robot 100) to maneuver into tight spaces (e.g., tight bathroom spaces), go underneath furniture, drive a cleaning element (e.g., a cleaning pad) into corners of an environment, and mostly or fully clean the edges of a given environment and/or space.

In accordance with such aspects, a robot (e.g., robot 100) is configured for cleaning. The robot 100 comprises a body (e.g., body 102) and a chassis (e.g., chassis 102c). The robot 100 further comprises a cleaning element (e.g., cleaning element 402). The cleaning element may comprise a substate mount (e.g., a VELCRO-based mount or a grommet-based mount) for receiving and holding a disposable hard surface wiping substate (e.g., a cleaning pad, such as cleaning pad 402p). The substate mount may include a width (402w), generally perpendicular to a forward direction of travel of the robot. In some aspects, the width may be less than or equal to about 13.9 cm. However, in alternative aspects, the width of the substate mount may be less than or equal to 11.5 cm. This reduced width allows for the robot to be decreased in overall size, but yet still allow the robot's components (e.g., motors 254m1 and motor 254m2) to fit within the robot's body yet allow the wheels to be far enough apart to allow the robot to turn even when the robot is stationary. For example, the width allows the development of sufficient torque to counter friction caused by cleaning element 402 (and/or its cleaning pad 402p) and turn the robot in place. Still further, in yet a further embodiment, the width of the substate mount may be reduced further to less than or equal to 7 cm (e.g., to a width of between 7 cm and 5 cm), which maintains sufficient sizing for components to fit, but also allows for cleaning in very space limited spaces, including, by way of non-limiting example, narrow, tight, or otherwise difficult spaces or environments within which a larger robot would have difficulty maneuvering.

The robot (e.g., robot 100) may further comprise a motor configured to move the robot within an environment (e.g., environment 800). The robot (e.g., robot 100) may further comprise a sensor and a processor communicatively coupled to the sensor. The sensor may comprise any of the sensors as described herein (e.g., a multi-directional sensor 108s1).

The robot (e.g., robot 100) may further comprise a set of computing instructions stored on the computer memory. The computing instructions may comprise JAVA, C++, C#, PYTHON, or other programming language-based instructions, for example as described herein, stored in the computer memory (e.g., as firmware). When the computing instructions are executed by the processor, to cause the processor to receive sensor data from the sensor. The computing instructions, when executed by the processor, may further cause the robot 100 to actuate the motor based on the sensor data to cause the robot 100 to maneuver within the environment.

In addition, in order to allow the robot 100 to maneuver within the environment, especially with respect to small, narrow, or tight spaces, the size, shape, or otherwise the dimensioning of the robot (e.g., robot 100), as well as the computing instructions of the robot, can be configured in various ways. For example, in one aspect, the robot 100 may be configured, such that when the processor executes the computing instructions, the processor causes the robot 100 to maneuver within the environment (e.g., robot 100) by implementing a predefined number of nonoverlapping or overlapping passes. This is shown, for example, by FIG. 11A, where each of the passes (e.g., represented by forward movements 1106f1-1106f13 comprise 13 passes. In some aspects, the predefined number of nonoverlapping or overlapping passes comprises ten or more passes (e.g., as illustrated for FIG. 11A) For example, each pass may comprise one square meter (m²) of floor coverage area.

In an additional example aspect, the robot (e.g., robot 100) may be configured, such that when the processor executes the computing instructions, the processor causes the robot to maneuver within the environment by implementing a predefined speed for each pass. For example, in some aspects, the predefined speed may be decelerated to reduce the intensity of impact of the robot with an obstacle within the environment to decrease debris falloff. Still further, in some aspects, a deceleration value from the predefined speed may comprise a value between 0.1 millimeters (mm) per second/per second to 33.30 mm per second/per second. Still further, in additional or alternative aspects, the predefined speed for each pass may comprise 100 millimeters per second (or less). That is, for a single pass, in some aspects the robot 100 can be configured to clean at rate of 100 or more seconds over one square meter (m²) of floor coverage area, which represents a size of a small room area, such as a bathroom. It should be noted, however, that a predefined speed may be selected from a range of speeds, such as, by way of non-limiting example, a speed of between 20 and 250 millimeters per second.

In further aspects, the height of the robot is configured to allow for the robot to maneuver under objects, e.g., objects or obstacles low to the ground. In one aspect, for example, the robot (e.g., robot 100) may have a height (e.g., height 502) of 9 centimeters (cm) or less. For example, in such aspects the height may range between 9 cm and 5 cm. In further aspects, the height of the robot may be reduced to 7 cm or less, e.g., where the height is between 5 cm and 7 cm. Such reduction in height allows the robot to get under or otherwise maneuver under a majority of toilet shapes or otherwise geometries. In still further aspects, the height of the robot 100 may be further reduced, e.g., to 5 centimeters or less, for example, 5 cm to 3 cm. Such configurations reduce the height of a given robot 100 allowing the robot to navigate under low hanging obstacles, e.g., shelving, toilet plumbing, door stops and the like.

In additional aspects, the body of the robot comprises a bumper (e.g., bumper 104), where the bumper has a corner radius (e.g., corner radius 104cr as shown for FIG. 3). In various aspects, the corner radius of the bumper may be between 0.5 millimeters to 30 millimeters. Such a small corner radius of the robot may allow the bumper, and as a consequence, the cleaning element 402 (e.g., comprising a pad 402p) positioned underneath, to fit closer to edges and/or fit into corners of a given environment allowing for a thorough clean of the environment.

In still further aspects, the cleaning element (e.g., cleaning element 402) of the robot (e.g., robot 100) may comprise a turn radius. The turn radius may be measured as a distance (e.g., distance 402bd) between a back edge of a portion (e.g., back edge 402) of a cleaning element (e.g., a pad of cleaning element 402) and a center of rotation (e.g., center of rotation 400c) of the robot (e.g., robot 100). A small turn radius allows the robot (e.g., robot 100) to rotate and maneuver in small spaces, corners, and other areas with limited room. For example, in some aspects, the turn radius may be less than 27.5 centimeters.

In still further aspects, the body of the robot comprises a bumper (e.g., bumper 104) where the bumper comprises at least a front bumper portion (e.g., front bumper portion 104fp). In such aspects, the cleaning element (e.g., cleaning element 402) comprises at least a front cleaning element portion (e.g., front edge 402fe). In some aspects, a distance (e.g., front side bumper distance 402fd) from the front bumper portion to the front cleaning element portion comprises less than 10 millimeters. The short distance between the cleaning element and the bumper allows the robot to have a maximum, otherwise large, surface area for attaching larger sized cleaning pads to cover a greater amount of a given floor coverage area.

In a similar aspect, the body of the robot comprises a bumper (e.g., bumper 104) having a least a side bumper portion (e.g., right bumper portion 104rsp and/or left bumper portion 104lsp). In such aspects, the cleaning element (e.g., cleaning element 402) comprises at least a side cleaning element portion (e.g., side of a cleaning pad). In such aspects, a distance (e.g., right side bumper distance 402rsd and/or left side bumper distance 402lsd) from the side bumper portion to the side cleaning element portion comprises less than 10 millimeters. As for the front side measurement, a short distance between the cleaning element and the bumper allows, at the sides, also the robot to have a maximum, otherwise large, surface area for attaching larger sized cleaning pads to cover a greater amount of a given floor coverage area.

In as still further aspects, the body (e.g., body 102) of the robot (e.g., robot 100) comprises a bumper (e.g., bumper 104) where the bumper is positioned at a distance between 2 mm to 10 mm from the body. The distance may be any of front side bumper distance 402fd, right side bumper distance 402rsd, and/or left side bumper distance 402lsd, or other distance as measured from any portion of the body 102 to the bumper 104.

### Additional Considerations

Although the disclosure herein sets forth a detailed description of numerous different aspects, it should be understood that the legal scope of the description is defined by the words of the claims set forth at the end of this patent and equivalents. The detailed description is to be construed as exemplary only and does not describe every possible aspect since describing every possible aspect would be impractical. Numerous alternative aspects may be implemented, using either current technology or technology developed after the filing date of this patent, which would still fall within the scope of the claims.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain aspects are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example aspects, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example aspects, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example aspects, the processor or processors may be located in a single location, while in other aspects the processors may be distributed across a number of locations.

The performance of certain of the operations may be distributed among the one or more processors, not only residing within a single machine, but deployed across a number of machines. In some example aspects, the one or more processors or processor-implemented modules may be located in a single geographic location (e.g., within a home environment, an office environment, or a server farm). In other aspects, the one or more processors or processor-implemented modules may be distributed across a number of geographic locations.

This detailed description is to be construed as exemplary only and does not describe every possible aspect, as describing every possible aspect would be impractical, if not impossible. A person of ordinary skill in the art may implement numerous alternate aspects, using either current technology or technology developed after the filing date of this application.

Those of ordinary skill in the art will recognize that a wide variety of modifications, alterations, and combinations can be made with respect to the above described aspects without departing from the scope of the invention, and that such modifications, alterations, and combinations are to be viewed as being within the ambit of the inventive concept.

The patent claims at the end of this patent application are not intended to be construed under 35 U.S.C. § 112 (f) unless traditional means-plus-function language is expressly recited, such as “means for” or “step for” language being explicitly recited in the claim(s). The systems and methods described herein are directed to an improvement to computer functionality, and improve the functioning of conventional computers.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular aspects of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A robot configured for cleaning, the robot comprising:
a body comprising a chassis and an outer perimeter;
a motor configured to move the robot within an environment;
a multi-directional sensor comprising a plurality of radial zones, wherein each radial zone defines direction relative to the robot;
a processor communicatively coupled to the multi-directional sensor;
a computer memory communicatively coupled to the processor; and
computing instructions stored on the computer memory and configured, when executed by the processor, to cause the processor to:
receive sensor data from the multi-directional sensor when at least a portion of the outer perimeter of the body of the robot contacts an object in the environment, and,
actuate the motor based on the sensor data to cause the robot to alter its course.

2. The robot according to claim 1, wherein the multi-directional sensor comprises:
an analog sensor;
a joystick sensor;
a magnetic field sensor; or
a potentiometer.

3. The robot according to claim 1, wherein the multi-directional sensor is a magnetic field sensor, and wherein one or more magnets are positioned on the outer perimeter of the robot to provide magnetic signals, and wherein the magnetic field sensor generates the sensor data based on the magnetic signals.

4. The robot according to claim 1, wherein the multi-directional sensor is a magnetic field sensor, and wherein one or more magnets are positioned on a surface of the robot to provide magnetic signals, and wherein the magnetic field sensor generates the sensor data based on the magnetic signals.

5. The robot according to claim 1, wherein the multi-directional sensor is a time-of-flight sensor.

6. The robot according to claim 5, wherein the sensor data comprises three-dimensional sensor data of one or more interior surfaces of the body of the robot, and wherein the 3D sensor data defines a distance of the one or more interior surfaces of the body of the robot with respect to the ToF sensor.

7. The robot according to claim 1, wherein the plurality of radial zones are configurable to have a specified number of radial zones.

8. The robot according to claim 1, wherein the plurality of radial zones comprises at least two radial zones.

9. The robot according to claim 1 further comprising:
a second multi-directional sensor,
wherein each of the second multi-directional sensor and the multi-directional sensor are coupled to at least a portion of the outer perimeter via a multi-axis sensor actuator, and
wherein the computing instructions are further configured, when executed by the processor, to cause the processor to:
receive second sensor data from the second multi-directional sensor when at least a portion of the outer perimeter of the body of the robot contacts the object in the environment, and,
actuate the motor further based on the second sensor data to cause the robot to alter its course.

10. The robot according to claim 9, wherein the multi-axis sensor actuator is configured actuate the sensor and the second sensor independently.

11. The robot according to claim 9, wherein the multi-axis sensor actuator is a dampening structure, wherein the dampening structure is coupled to the multi-directional sensor and the second multi-directional sensor and is sufficiently rigid to move the multi-directional sensor and/or the second multi-directional sensor when a force is applied to the multi-axis sensor actuator.

12. The robot according to claim 9, wherein the multi-axis sensor actuator is sufficiently rigid to apply a first actuation force to the multi-directional sensor and/or a second actuation force to the second multi-directional sensor.

13. The robot according to claim 9, wherein the multi-axis sensor actuator is limited to one more directions and/or one or more distances of travel within or with respect to the body of the robot to prevent actuating at least one of the multi-directional sensor or the second multi-directional sensor to a fully actuated position.

14. The robot according to claim 9, wherein the multi-axis sensor actuator is configured to be deformed in a shape, wherein deformation of the shape creates a change in sensor data output by at least one of the multi-directional sensor or the second multi-directional sensor.

15. The robot according to claim 9, wherein the multi-axis sensor actuator, the multi-directional sensor, and the second multi-directional sensor comprise a synthetic sensor, and wherein computing instructions stored on the computer memory, when executed by the processor, are further configured to cause the processor to:
generate synthetic sensor data based on the sensor data of the multi-directional sensor and the second sensor data of the second multi-directional sensor.

16. The robot according to claim 15, wherein the synthetic sensor data comprises data computed using each of the sensor data and the second sensor data, wherein the sensor data and the second sensor data differ based on at least one of: direction or magnitude.
